(19) United States
(12) Patent Application Publication
(10) Pub. No.: US 2026/0349377 A1
(43) Pub. Date: Nov. 5, 2026

(54) IMAGE FORMING APPARATUS

(71) Applicant: CANON KABUSHIKI KAISHA, Tokyo (JP)

(72) Inventors: TOMOO AKIZUKI, Kanagawa (JP); SHUHEI TOKIWA, Tokyo (JP)

(21) Appl. No.: 19/560,929

(22) Filed: Mar. 9, 2026

(30) Foreign Application Priority Data
Mar. 10, 2025 (JP) 2025-037379

(51) Int. Cl. G03G 15/00; G03G 15/02; G03G 15/06; G03G 15/16

(52) U.S. Cl. CPC G03G 15/5004; G03G 15/0266; G03G 15/065; G03G 15/167; G03G 15/5037

(57) ABSTRACT

A potential difference between a non-image portion potential and a developing voltage in a developing position before a surface of a photosensitive drum is positioned in a transfer position where a recording material is nipped is defined as a first potential difference. The potential difference in the developing position immediately before a leading end of the recording material reaches the transfer position and before the surface of the photosensitive drum providing the first potential difference passes through the transfer position is defined as a second potential difference. The potential difference in the developing position before the surface of the photosensitive drum providing the second potential difference passes through the transfer position where the recording material is not nipped is defined as a third potential difference. The controller controls a charging voltage and a developing voltage to satisfy: (first potential difference)>(second potential difference)>(third potential difference).

### BACKGROUND

### Field of the Technology

The present disclosure relates to an image forming apparatus, such as a laser printer, a copying machine, or a facsimile apparatus, using an electrophotographic process.

### Description of the Related Art

Conventionally, in the image forming apparatus using the electrophotographic process, for the purpose of downsizing and simplification of a high-voltage circuit, an image forming apparatus provided with a charging device of a DC charging type has been known. In the case where a photosensitive drum is electrically charged by the DC charging type, a converging property of a charge potential as in an AC charging type cannot be obtained, and therefore, a problem on use of the DC charging type occurs in some instances. For example, in the DC charging type, compared with an image forming apparatus using the AC charging type, transfer of toner from a developing roller onto a non-image portion where an electrostatic latent image on the photosensitive drum is not formed (hereinafter, this transfer is referred to as a fog) is liable to occur.

The fog has the influence on an image quality and largely depends on a potential difference between a surface potential of the photosensitive drum and a developing voltage is referred to as a back contrast (hereinafter, represented by Vback). In the DC charging type, the surface potential of the photosensitive drum and an applied voltage to the charging roller do not provide a unique relationship, so that it is difficult to control Vback so as to suppress the fog within a predetermined range. On the other hand, there is a method in which an appropriate charging voltage is applied to the photosensitive drum correspondingly to an ambient atmospheric environment. In Japanese Laid-Open Patent Application No. 2007-212867, a method in which a current flowing during charging is subjected to constant-current control and a value of a DC voltage for development is determined on the basis of a DC voltage applied during DC charging and in which a value of an optimum Vback is obtained in every ambient environment is disclosed.

However, in the above-described conventional control, the following problem arises. In an image forming apparatus of a direct transfer type in which the toner image on the photosensitive drum is transferred onto the recording material, there is a problem such that even when a charging voltage and a developing voltage which provide an optimum Vback are used, a good image cannot be obtained in a region (range) corresponding to one-full circumference of the photosensitive drum from a leading end of the recording material. For example, in this range, an image defect such that an image density becomes thin in a half-tone portion occurs in some instances.

### SUMMARY

The present disclosure has been accomplished in view of the above-described circumstances and is directed to suppress an image defect occurring in a recording material leading end.

In order to solve the above-described problem, according to an aspect of the present disclosure, there is provided an image forming apparatus configured to execute an image forming operation for forming an image on a recording material, the image forming apparatus comprising: a photosensitive drum; a charging roller configured to electrically charge a surface of the photosensitive drum in a charging position where the charging roller contacts the surface of the photosensitive drum; a charging voltage applying portion configured to apply a charging voltage to the charging roller; a developing roller configured to supply toner to the surface of the photosensitive drum in a developing position where the developing roller contacts the surface of the photosensitive drum; a developing voltage applying portion configured to apply a developing voltage to the developing roller; a transfer roller configured to transfer the toner on the photosensitive drum onto the recording material in a transfer position where the surface of the photosensitive drum contacts the transfer roller; a transfer voltage applying portion configured to apply a transfer voltage to the transfer roller; and a controller configured to control the charging voltage applying portion, the developing voltage applying portion, and the transfer voltage applying portion, wherein a potential of a region of the surface of the photosensitive drum charged by the charging roller is defined as a non-image portion potential, a potential difference between the non-image portion potential and the developing voltage when the surface of the photosensitive drum is positioned in the developing position before being positioned in the transfer position when the recording material is nipped between the transfer roller and the photosensitive drum is defined as a first potential difference, the potential difference when the surface of the photosensitive drum is positioned in the developing position immediately before a leading end of the recording material reaches the transfer position and before the surface of the photosensitive drum providing the first potential difference passes through the transfer position is defined as a second potential difference, and the potential difference when the surface of the photosensitive drum is positioned in the developing position before the surface of the photosensitive drum providing the second potential difference passes through the transfer position and before the surface of the photosensitive drum is positioned in the transfer position when the recording material is not nipped between the transfer roller and the photosensitive drum is defined as a third potential difference, and wherein in a state in which the transfer voltage is applied in a case where an operation of the image forming apparatus is shifted from a non-image forming operation to the image forming operation, the controller controls the charging voltage and the developing voltage so as to satisfy the following relationship:

(first potential difference)>(second potential difference)>(third potential difference).

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus according to embodiments 1 to 3.

FIG. 2 is a block diagram showing a control constitution of the image forming apparatus of the embodiments 1 to 3.

FIG. 3 is a schematic sectional view of a developing device in the embodiments 1 to 3.

FIG. 4 is a schematic view of an exposure device in the embodiments 1 to 3.

FIG. 5 is a timing chart of a print sequence in the embodiment 1.

FIG. 6 includes graphs each for illustrating a microscopic surface potential in an associated position of a photosensitive drum.

FIG. 7 is a graph for illustrating a toner deposition amount on a transfer roller surface.

FIG. 8 is a timing chart of a print sequence in the embodiment 2.

FIG. 9 is a timing chart of a print sequence in the embodiment 3.

FIG. 10 is a graph showing a reach between Vback and a fog toner amount.

### DESCRIPTION OF THE EMBODIMENTS

In the following, an image forming apparatus according to the present disclosure will be described specifically with reference to the drawings. However, materials, shapes, a relative arrangement, and the like of constituent parts described in the following embodiments should be appropriately changed depending on constitutions and various conditions of apparatuses (devices) to which the present disclosure is applied, and a scope of the present disclosure is not intended to be limited to the following embodiments.

Further, in the following description and the respective drawings, a vertical direction in the case where the image forming apparatus is installed on a horizontal surface is a Z direction. A direction, crossing the Z direction, of a rotational axis of a photosensitive drum described later (a rotational axis direction of the photosensitive drum) is a Y direction. A direction crossing both the Z direction and the Y direction is an X direction. The X direction and the Y direction may preferably be a horizontal direction. Further, the X direction, the Y direction, and the Z direction may preferably be perpendicular to each other. Further, as desired, the directions of arrows X, Y, and Z illustrated in the drawings are represented by +X side, +Y side, and +Z side, respectively and sides opposite to these sides are represented by −X side, −Y side, and −Z side, respectively.

### 1. General Structure and Operation of Image Forming Apparatus

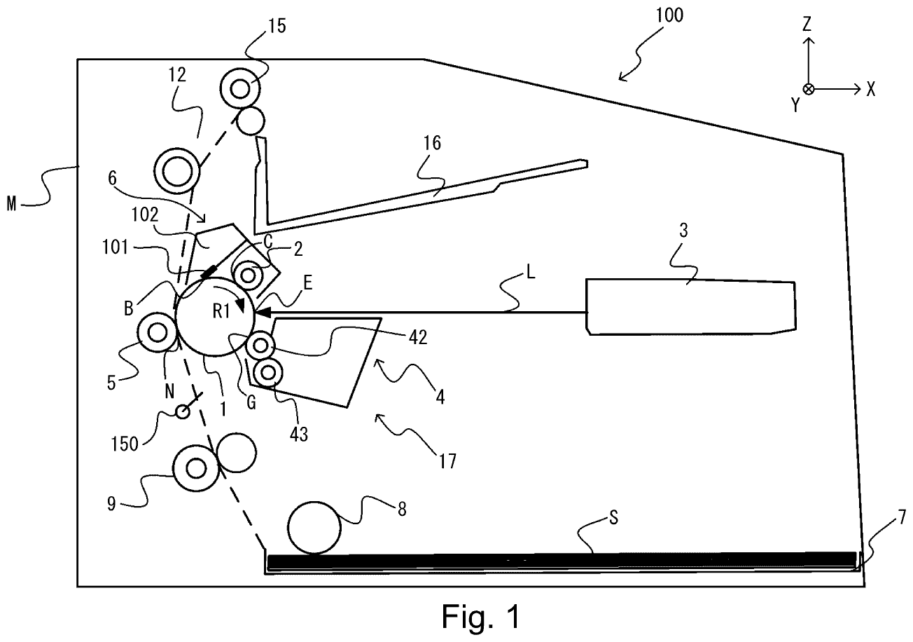

FIG. 1 is a schematic sectional view of an image forming apparatus 100 of an embodiment 1. The image forming apparatus 100 of the embodiment 1 is constituted so as to execute an image forming operation for forming an image on a recording material. The image forming apparatus 100 is a monochromatic laser printer capable of forming a black (monochromatic) image on a sheet-like recording material S as a toner image-receiving member by using an electrophotographic type.

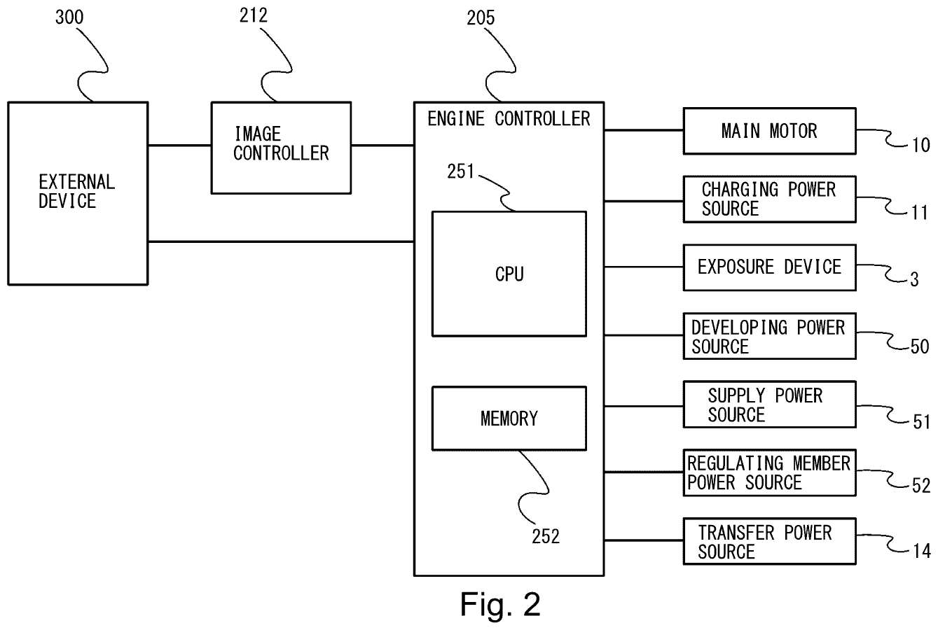

The image forming apparatus 100 includes a photosensitive drum 1 which is a rotatable drum-shaped (cylindrical) photosensitive member (electrophotographic photosensitive member) as an image bearing member. When the photosensitive drum 1 is viewed in a rotational axis direction thereof, a diameter of the photosensitive drum 1 is 24 mm. When a print signal is inputted to the image forming apparatus 100, the photosensitive drum 1 is rotationally driven at a predetermined peripheral speed in a rotational direction R1 (clockwise direction) in FIG. 1 by a main motor 10 (FIG. 2) as a driving source constituting a driving means. In the embodiment 1, a process speed of the image forming apparatus 100 corresponding to the peripheral speed of the photosensitive drum 1 is 250 mm/s.

At a periphery of the photosensitive drum 1, along a rotational direction of the photosensitive drum 1, a charging roller 2, an exposure device 3, a developing device 4, a transfer roller 5, and a cleaning device 6 are sequentially provided in a named order. Further, at a lower portion of the image forming apparatus 100, a cassette 7 in which recording materials S are accommodated is provided. Along a conveying passage of the recording material S from the cassette 7, a feeding roller 8, a conveying roller 9, a top sensor 150, a transfer roller 5, a fixing device 12, a discharging roller 15, and a discharge tray 16 are provided in a named order.

A surface of a rotating photosensitive drum 1 is electrically charged uniformly to a predetermined polarity (negative polarity in the embodiment 1) and a predetermined potential by the charging roller 2 which is a roller-type charging member. The charging roller 2 constitutes a charging device as the charging means. The charging roller 2 forms a charging position (charging nip) C in contact with the photosensitive drum 1. That is, the charging roller 2 charges the surface of the photosensitive drum 1 by electric discharge in a gap formed in the neighborhood of the charging position C. During the charging, to the charging roller 2, a predetermined charging voltage (charging voltage) which is a DC voltage of the same polarity (negative polarity in the embodiment 1) as a charge polarity of the photosensitive drum 1 is applied by a charging power source (high-voltage power source) 11 (FIG. 2) as a charging voltage applying means (charging voltage applying portion). The charging power source applies the charging voltage to the charging roller 2. The charged surface of the photosensitive drum 1 is subjected to scanning exposure by an exposure device 3 as an exposure means depending on an image signal (image information) inputted to the image forming apparatus 100, so that an electrostatic latent image (latent image, electrostatic image) is formed on the photosensitive drum 1. The exposure device 3 is an example of an exposure portion where the surface of the photosensitive drum 1 charged by the charging roller 2 is irradiated with laser light depending on image data. The exposure device 3 will be further described specifically later. The electrostatic latent image formed on the photosensitive drum 1 is developed (visualized) by being supplied with toner as a developer by the developing device 4 as a developing means, so that a toner image (developer image) is formed on the photosensitive drum 1. A developing roller 42 provided in the developing device 4 forms a developing position (developing nip) G in contact with the photosensitive drum 1. That is, the developing roller 42 develops the latent image on the photosensitive drum 1 with toner in the developing position G, and thus forms the toner image. The developing device 4 will be further described specifically later.

A transfer roller 5 which is a roller-type transfer member is provided opposed to the photosensitive drum 1. The transfer roller 5 constitutes a transfer device as a transfer means. The transfer roller 5 is pressed toward the photosensitive drum 1 and forms a transfer position (transfer nip) N where the photosensitive drum 1 and the transfer roller 5 are in contact with each other. That is, the transfer roller 5 transfers the toner image, on the photosensitive drum 1, onto the recording material in the transfer position N. In the transfer position N, the toner image formed on the photosensitive drum 1 is transferred onto a recording material S nipped and conveyed by the photosensitive drum 1 and the transfer roller 5. During the transfer, to the transfer roller 5, a predetermined transfer voltage (transfer voltage) which is a DC voltage of an opposite polarity (positive polarity in the embodiment 1) to a normal charge polarity (normal polarity) of the toner is applied by a transfer power source (high-voltage power source) 14 (FIG. 2) as a transfer voltage applying means (transfer voltage applying portion). The transfer power source 14 applies the transfer voltage to the transfer roller 5.

The recording material (recording medium, transfer material, sheet) S such as paper is accommodated in the cassette 7 as a recording material accommodating portion. The recording material S accommodated in the cassette 7 is separated and fed one by one from the cassette 7 by the feeding roller 8 as a feeding member and is conveyed toward the conveying roller 9. This recording material S is supplied to the transfer position N by the conveying roller (registration roller) 9 as a conveying member so as to be timed to the toner image on the photosensitive drum 1. With respect to a conveying direction of the recording material S, between the conveying roller 9 and the transfer position N, as a recording material detecting means for detecting the recording material S, the top sensor 150 for detecting a leading end of the recording material S with respect to the conveying direction of the recording material S is provided. A signal indicating a detection result of the top sensor 150 is inputted to an engine controller 205 (FIG. 2) described later, and is used for control of an image writing timing by the exposure device 3, or the like.

The recording material S on which the toner image is transferred is conveyed to the fixing device 12 as a fixing means. The fixing device 12 fixes (melts, sticks) the toner image on the recording material S by heating and pressing the recording material S on which an unfixed toner image is carried. The recording material S on which the toner image is fixed is discharged (output) onto the discharge tray 16 as a discharge portion provided outside the apparatus main assembly M, by the discharging roller 15 as a conveying member.

Further, the toner (transfer residual toner) remaining on the photosensitive drum 1 after the transfer of the toner image onto the recording material S is removed and collected from the surface of the photosensitive drum 1 by the cleaning device 6 as a cleaning means. The cleaning device 6 includes a cleaning blade 101 as a cleaning member provided so as to contact the surface of the photosensitive drum 1 and includes a cleaning container 102. The cleaning blade 101 contacts the photosensitive drum 1 and forms a cleaning portion (cleaning nip) B. Further, by the cleaning blade 101, the cleaning device 6 scrapes off the transfer residual toner from the surface of the rotating photosensitive drum 1 and collects the transfer residual toner in the cleaning container 102.

Here, with respect to the rotational direction R1 of the photosensitive drum 1, a position on the photosensitive drum 1 where the charging roller 2 charges the photosensitive drum 1 is a charging portion (charging position) C. The charging roller 2 charges the photosensitive drum 1 by electric discharge generating in at least one of minute gaps between the photosensitive drum 1 and the charging roller 2 on sides upstream and downstream of a contact portion between the photosensitive drum 1 and the charging roller 2 with respect to the rotational direction R1 of the photosensitive drum 1. However, for simplification, herein, description will be made by regarding the contact portion on the photosensitive drum 1 with the charging roller 2 as the charging position C. Further, with respect to the rotational direction R1 of the photosensitive drum 1, a position on the photosensitive drum 1 irradiated with laser light L by the exposure device 3 is an exposure portion (exposure position) E. Further, with respect to the rotational direction R1 of the photosensitive drum 1, a position on the photosensitive drum 1 (a contact portion on the photosensitive drum 1 with the developing roller 42 in the embodiment 1) where the toner is supplied by the developing roller 42 is a developing portion (developing position) G. Further, with respect to the rotational direction R1 of the photosensitive drum 1, a position on the photosensitive drum 1 (a contact portion on the photosensitive drum 1 with the transfer roller 5 in the embodiment 1) where the toner image is transferred onto the recording material S is a transfer portion (transfer position) N. Further, with respect to the rotational direction R1 of the photosensitive drum 1, a position on the photosensitive drum 1 (a contact portion on the photosensitive drum 1 with the cleaning blade 101 in the embodiment 1) where the toner is removed by the cleaning blade 101 is a cleaning portion (cleaning position) B. Incidentally, each of the charging position C, the developing position G, and the transfer position N is represented by a center position with respect to the rotational direction R1 of the photosensitive drum 1. In the embodiment 1, the image forming apparatus 100 does not include a discharging device (pre-exposure device or the like) for discharging the surface of the photosensitive drum 1 on a side downstream of the transfer position N and upstream of the charging position C with respect to the rotational direction R1 of the photosensitive drum 1.

Further, in the embodiment 1, the photosensitive drum 1, and as process means actable thereon, the charging roller 2, the developing device 4, and the cleaning device 6 are integrally assembled into a cartridge and constitute a process cartridge 17 detachably mountable to the apparatus main assembly M. Incidentally, the apparatus main assembly M of the image forming apparatus 100 is a portion such that the process cartridge 17 is removed from the image forming apparatus 100.

FIG. 2 is a block diagram showing a control constitution of the image forming apparatus 100 of the embodiment 1. The image forming apparatus 100 is provided with the engine controller 205 as a control means. The engine controller 205 is constituted by including a CPU 251 as an arithmetic (operation) processing means which is a central element for performing arithmetic (operation) processing, a memory (storing medium) 252, such as a ROM, a RAM, or a non-volatile memory, as a storing means, an input/output portion (not shown), and the like. In the ROM, a control program, a data table acquired in advance, and the like are stored, and in the RAM, information on detection results of various sensors, operation (calculation) results, and the like are stored. In the non-volatile memory, various pieces of setting information, information on a lifetime of each of members, and the like are stored. The input/output portion (I/F) transfers signals between the engine controller 205 and an external device of the engine controller 205.

To the engine controller 205, for example, a main motor 10, the charging power source 11, a developing power source 50 described later, a supplying power source 51 described later, a regulating member power source 52 described later, the exposure device 3, the transfer power source 14, and the like are connected, and are operated by being controlled by the engine controller 205. Incidentally, each of the charging power source 11, the developing power source 50, the supplying power source 51, the regulating member power source 52, and the transfer power source 14 is constituted by including an associated transformer and the like. The engine controller 205 is an example of a controller for controlling the charging power source, the developing power source, and the transfer power source.

The engine controller 205 integrally controls and operates the respective portions of the image forming apparatus 100 in accordance with the control program or the data table. To the engine controller 205, a print signal (a control instruction such as an image signal, an image formation start signal, and the like) is inputted from an external device (host computer in the embodiment 1) 300 such as a host computer (personal computer or the like), an image reading device or the like. In accordance with the inputted print signal, the engine controller 205 controls the respective portions of the image forming apparatus 100 and causes the portions to execute a print sequence (print operation, job).

### 2. Photosensitive Drum

In the embodiment 1, the photosensitive drum 1 is constituted by laminating, on an aluminum cylinder as a supporting member formed of an electroconductive material, an undercoat layer having an electrical barrier property, a charge generating layer and a charge transporting layer in a named order. The charge transporting layer constituting an outermost surface of the photosensitive drum 1 contacting the charging roller 2 is formed using polycarbonate resin. Further, in the embodiment 1, a surface potential of the photosensitive drum 1 formed by being charged by the charging roller 2 during image formation (hereinafter this potential is referred to also as a “dark (portion) potential”) is −500 V.

### 3. Cleaning Blade

The cleaning blade 101 contacts the surface of the photosensitive drum 1 on a side downstream of the transfer position N and upstream of the charging position C with respect to the rotational direction R1 of the photosensitive drum 1, and removes the toner on the photosensitive drum 1 from the photosensitive drum 1.

The cleaning blade 101 is constituted by including a supporting metal plate and a rubber portion which has elasticity and which is fixed to a free end portion of the supporting metal plate so as to be contactable to the photosensitive drum 1. The rubber portion of the cleaning blade 101 is constituted by a plate-like member which has a predetermined length in each of a longitudinal direction and a widthwise direction substantially perpendicular to the longitudinal direction, which has a predetermined thickness, and which is formed with an elastic material. The rubber portion of the cleaning blade 101 is disposed so that the longitudinal direction thereof is substantially parallel to a direction substantially perpendicular to a movement direction of the surface of the photosensitive drum 1. Further, the rubber portion of the cleaning blade 101 contacts the surface of the photosensitive drum 1 in a counter direction to the rotational direction of the photosensitive drum 1 so that the free end portion (of the rubber portion) with respect to the widthwise direction is directed toward an upstream side of the movement direction of the surface of the photosensitive drum 1. By this, the cleaning blade 101 removes the toner from the surface of the photosensitive drum 1 in a scraping-off manner. In the embodiment 1, the rubber portion of the cleaning blade 101 is formed of polyurethane (urethane rubber), and is 75° in Wallace hardness and 2 mm in thickness. Further, in the embodiment 1, the cleaning blade 101 contacts the surface of the photosensitive drum 1 under a setting of a contact angle (angle formed between itself and a tangential line of the photosensitive drum 1 at the contact portion therebetween) of 30° and a contact pressure (set pressure) of 30 gf/cm.

### 4. Developing Device

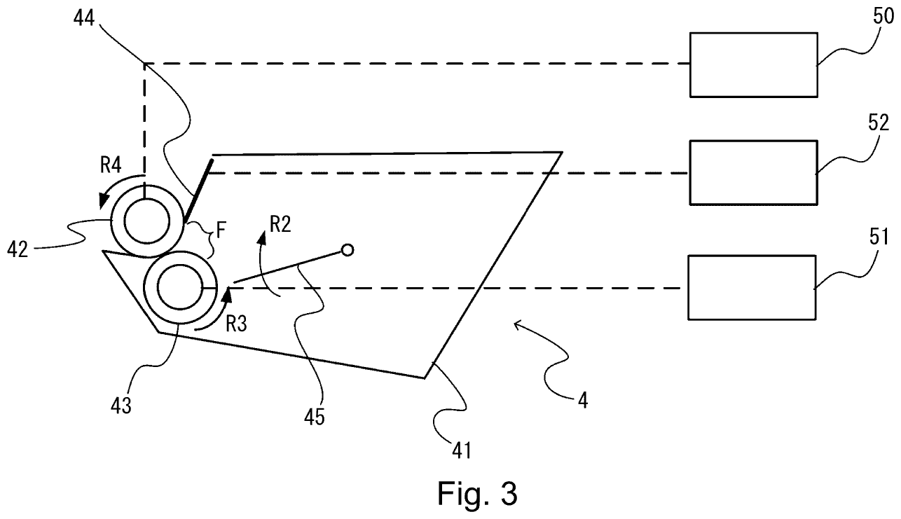

FIG. 3 is a schematic sectional view of the developing device 4 in the embodiment 1. In the embodiment 1, the developing device 4 employs a contact development type, and uses, as the developer, a negatively chargeable non-magnetic one-component developer (toner) of which normal polarity (principal charge polarity of the toner during the development) is the negative polarity. Further, in the embodiment 1, the developing device 4 employs a reverse development type. The developing device 4 carries out the development by depositing the toner, charged to the same polarity (negative polarity in the embodiment 1) as the charge polarity of the photosensitive drum 1, on an image portion on the photosensitive drum 1 lowered in absolute value of the potential by being exposed to light after being charged uniformly.

The developing device 4 includes a developing container 41 as a developer accommodating portion for accommodating the toner, and the developing roller 42 as a developing member (developer carrying member) for carrying and conveying the toner. Further, the developing device 4 includes a supplying roller 43 as a developer supplying member for supplying the toner to the developing roller 42, and a developing blade 44 as a developer regulating member for regulating an amount of the toner carried by the developing roller 42. The supplying roller 43 and the developing blade 44 are disposed so as to contact the developing roller 42. Further, in the developing container 41 (at a substantially central portion in the embodiment 1), a stirring member 45 for stirring the toner and for supplying the toner to the supplying roller 43 is provided. To the developing roller 42, the developing power source (high-voltage power source) 50 as a developing voltage applying means (developing voltage applying portion) is connected. The developing power source 50 applies the developing voltage to the developing roller 42.

Further, to the supplying roller 43, the supplying power source (high-voltage power source) 51 as a supplying voltage applying means (supplying voltage applying portion) is connected. Further, to the developing blade 44, the regulating member power source (high-voltage power source) 52 as a regulating member voltage applying means (regulating member voltage applying portion) is connected.

In the embodiment 1, the image forming apparatus 100 is not provided with a developing contact and separation mechanism for permitting contact of the developing roller 42 to the photosensitive drum 1 and separation of the developing roller 42 from the photosensitive drum 1. That is, in the embodiment 1, the developing roller 42 always contacts the photosensitive drum 1 in a state that the developing device 4 (process cartridge 17) is disposed in a predetermined position in the apparatus main assembly M. The developing roller 42 is rotationally driven in an arrow R4 direction (counterclockwise direction) in FIG. 3. That is, in a contact portion between the photosensitive drum 1 and the developing roller 42, the developing roller 42 is rotationally driven so that the surface of the photosensitive drum 1 and a surface of the developing roller 42 move in a forward direction. Further, the supplying roller 43 is rotationally driven in an arrow R3 direction (counterclockwise direction) in FIG. 3. That is, in a contact portion between the developing roller 42 and the supplying roller 43, the supplying roller 43 is rotationally driven so that the surface of the developing roller 42 and a surface of the supplying roller 43 move in opposite directions. Further, the stirring member 45 is rotationally driven in an arrow R2 direction (clockwise direction) in FIG. 3. In the embodiment 1, the developing roller 42, the supplying roller 43, and the stirring member 45 are rotated by transmitting a driving force thereto from the main motor 10 which is a driving source common to the main motor 10 and the photosensitive drum 1. The developing roller 42, the supplying roller 43, and the stirring member 45 are rotated in synchronism with the photosensitive drum 1, and rotations of these members are stopped in synchronism with the photosensitive drum 1.

During development, to the developing roller 42, a developing voltage which is a DC voltage of the same polarity (negative polarity in the embodiment 1) as the normal polarity of the toner is applied by the developing power source 50. Further, during the development, to the supplying roller 43, a supplying voltage which is a DC voltage, larger in absolute value than the developing voltage, of the same polarity (negative polarity in the embodiment 1) as the normal polarity of the toner is applied by the supplying power source 51. Further, during the development, to the developing blade 44, a regulating member voltage which is a DC voltage, larger in absolute value than the developing voltage, of the same polarity (negative polarity in the embodiment 1) as the normal polarity of the toner is applied by the regulating member power source 52.

A developing operation of the developing device 4 will be described. By the rotation of the stirring member 45, the toner is supplied to a region F in the neighborhood of the contact portion between the developing roller 42 and the supplying roller 43, and then is once stored in the region F. The toner stored in the region F is supplied to the developing roller 42 by the rotation of the supplying roller 43. The toner supplied to the developing roller 42 passes through a contact portion between the developing roller 42 and the developing blade 44 and is formed in a layer (coated) in an appropriate thickness by the rotation of the developing roller 42 and then is carried on the developing roller 42. At this time, the toner supplied to the developing roller 42 is rubbed with the surface of the developing blade 44, and thus is triboelectrically charged to the negative polarity.

The toner coated on the developing roller 42 is conveyed to the developing position G which is the contact portion between the photosensitive drum 1 and the developing roller 42 by the rotation of the developing roller 42. At the developing position G, a part of the toner coated on the developing roller 42 is transferred and deposited on the photosensitive drum 1 by an electric field formed by a potential difference between a potential of an image portion of the electrostatic latent image formed on the photosensitive drum 1 and the developing voltage applied to the developing roller 42. Thus, the electrostatic latent image is developed (visualized) into a toner image. The toner remaining on the developing roller 42 without being used for development in the developing position G is scraped off from the surface of the developing roller 42 by the rotating supplying roller 43 at the contact portion between the developing roller 42 and the supplying roller 43, and then the toner stored in the region F is newly supplied onto the surface of the developing roller 42.

### Fog

Here, in the image forming apparatus using the electrophotographic process, there arises a phenomenon that the toner is deposited on a non-image portion of the surface of the photosensitive drum 1. This phenomenon is referred to as a “fog”. In general, the fog is controlled by a potential difference between the surface potential of the photosensitive drum 1 and a potential of the developing roller 42 when the charged surface of the photosensitive drum 1 reaches the developing position G. This potential difference is referred to as a “back contrast” (hereinafter, also referred to as “Vback”). Usually, Vback is set for an electric charge held by the toner so that an electric field formed between the photosensitive drum 1 and the developing roller 42 becomes an electric field in which the toner is not moved from the developing roller 42 side to the photosensitive drum 1 side. Incidentally, in the embodiment 1, natural attenuation of the surface potential of the photosensitive drum 1 during movement of the surface of the photosensitive drum 1 from the charging position C to the developing position G is to a negligible degree.

By appropriately controlling the Vback, it is possible to prevent excessive toner from being deposited on the non-image portion which is a portion on which the toner should not be deposited. In the case where the Vback is smaller than a predetermined value, an electric field for retaining the toner, charged to the normal polarity (negative polarity in the embodiment 1), on the developing roller 42 is weakened, so that a fog (normal fog) such that the toner charged to the normal polarity is deposited on the non-image portion on the photosensitive drum 1 occurs. Conversely, in the case where the Vback is larger than the predetermined value, the electric field for retaining the toner, charged to the normal polarity (negative polarity in the embodiment 1), on the developing roller 42 is strengthened. On the other hand, by the influence of this strengthened electric field, toner (reversely charged toner) charged to an opposite polarity (positive polarity in the embodiment 1) to the normal polarity on the developing roller 42 occurs, so that a fog (reverse charge fog) such that the reversely charged toner is deposited on the non-image portion on photosensitive drum 1 occurs.

In the embodiment 1, during the image formation, a charging voltage of −1100 V is applied to the charging roller 2, so that the surface of the photosensitive drum 1 is charged uniformly to a dark (portion) potential Vd of −600 V. The charged surface of the photosensitive drum 1 is exposed to light by the exposure device 3 depending on an image signal, so that a light (portion) potential Vl of −250 V is formed. Further, during the image formation, to the developing roller 42, a developing voltage Vdc of −400 V is applied. The light (portion) potential Vl is an example of an image portion potential which is a potential in a region of the surface of the photosensitive drum 1 irradiated with the laser light, and the dark (portion) potential Vd is an example of a non-image portion potential which is a potential in a region of the surface of the photosensitive drum 1 charged by the charging roller.

An image portion (image region) and a non-image portion (non-image region) are formed in an image formable region on the photosensitive drum 1. The image formable region is a region in which the toner is capable of being supplied from the surface of the developing roller 42 to the surface of the photosensitive drum 1. In the embodiment 1, a “developing contrast” which is a potential difference (=|Vl−Vdc|) between the light potential Vl and the developing voltage Vdc on the photosensitive drum 1 in the developing position G during the image formation (hereinafter, this developing contrast is also referred to as “Vcont”) is 150 V. This can also be said that the developing voltage Vdc is higher than the light potential Vl on a normal polarity side of the toner. Further, in the embodiment 1, a back contrast Vback which is a potential difference (=|Vd−Vdc|) between the dark potential Vd and the developing voltage Vdc on the photosensitive drum 1 in the developing portion G is 200 V. This can also be said that the dark-portion potential Vd is higher than the developing voltage Vdc on the normal polarity side of the toner). Incidentally, each of Vcont and Vback is represented by a potential difference between a surface potential of the photosensitive drum 1 in the developing position G and the developing voltage applied to a core metal of the developing roller 42. Further, the voltage is represented by a potential difference between an associated potential and a ground potential (0 V).

### 5. Exposure Device

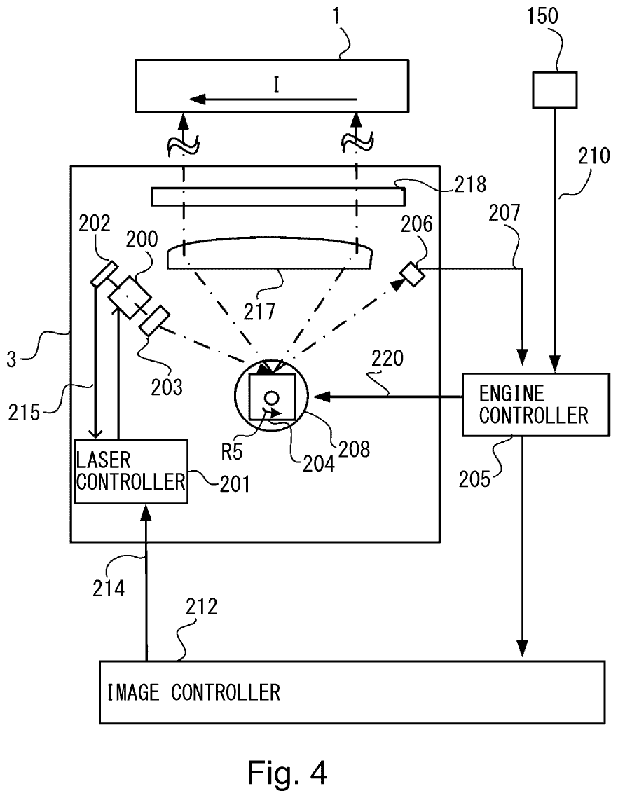

FIG. 4 is a schematic view showing a structure of the exposure device 3 and a periphery thereof in the embodiment 1. In the embodiment 1, the exposure device 3 is constituted by a laser scanner (laser exposure device). To the exposure device 3, the engine controller 205 and an image controller 212 are connected. The engine controller 205 and the image controller 212 control an operation of the exposure device 3. In the embodiment 1, the engine controller 205 and the image controller 212 are provided on different substrates.

The exposure device 3 includes a laser light source 200, a collimator lens 203, a rotatable polygon mirror 204, a photodiode (hereinafter, referred to as PD) 202, a beam sensor (Beam Detect hereinafter, referred to as BD) 206, an f-θ lens 217, and a fold-back mirror 218. Further, the exposure device 3 includes a laser controller 201 for carrying out light emission control of the laser light source 200 depending on a video signal (image data signal) 214 inputted from the image controller 212. On the basis of an image signal inputted from a host computer 300 (FIG. 2), the image controller 212 performs processing for generating the video signal 214 for carrying out the light emission control of the exposure device 3, or the like.

The laser light source 200 emits laser light in two directions by a light-emitting element. Laser light emitted in one direction from the laser light source 200 is indicated on the photodiode 202. The photodiode 202 converts the incident laser light into an electric signal and sends as a PD signal 215 to the laser controller 201. On the basis of the PD signal 215, the laser controller 201 carries out output light quantity control (APC: Auto Power Control) of the laser light source 200 so that the laser light has a predetermined light quantity.

Laser light emitted in the other direction from the laser light source 200 is irradiated to the rotatable polygon mirror 204 via the collimator lens 203. The rotatable polygon mirror 204 is a rotatable polygonal mirror which has a plurality of reflection surfaces and which is rotationally driven in an arrow R5 direction (counterclockwise direction) in FIG. 4 by a motor 208. The rotatable polygon mirror 204 in the embodiment 1 has four reflection surfaces (faces). The motor 208 rotationally drives the rotatable polygon mirror 204 depending on a driving signal 220 output from the engine controller 205.

When a print signal is inputted from the host computer 300 (FIG. 2) to the engine controller 205, the engine controller 205 starts a print sequence as described later, so that the engine controller 205 starts not only rotational drive of the photosensitive drum 1 and the like but also rotational drive of the rotatable polygon mirror 204. The laser light irradiated to the rotatable polygon mirror 204 is deflected in a direction of the photosensitive drum 1 by the reflection surface. By the rotation of the rotatable polygon mirror 204, a deflection angle changes. By this change in deflection angle, the surface of the photosensitive drum 1 is scanned with the laser light with respect to an arrow I direction (direction substantially perpendicular to a movement direction of the surface of the photosensitive drum 1) in FIG. 4. This laser light is corrected in optical path by the f-θ lens 217 so as to scan the photosensitive drum 1 at a constant speed, and the photosensitive drum 1 is irradiated with the laser light via the fold-back mirror 218.

The laser light deflected by the rotatable polygonal mirror 204 is partially received by the BD 206. In the embodiment 1, the BD 206 is disposed at a position where the laser light is capable of being detected before the scanning of the photosensitive drum 1 with the laser light is started. On the basis of the detected laser light, the BD 206 generates a BD signal 207 having a first level and a second level, and sends the BD signal 207 to the engine controller 205. The BD signal 207 is, for example, a negative logic signal, and is a detection signal such that the level thereof is the first level (Low) during detection of the laser light by the BD 206 and is the second level (High) during non-detection of the laser light by the BD 206. On the basis of the acquired BD signal 207, the engine controller 205 controls the motor 208 so that a rotation period of the rotatable polygon mirror 204 becomes a predetermined period. The engine controller 205 discriminates that a period of the BD signal 207 becomes a predetermined period and thus the rotation period of the rotatable polygon mirror 204 is stable at the predetermined period. That is, the engine controller 205 adjusts the driving signal 220 on the basis of the BD signal 207 and thus carries out feed-back control so that the rotation of the rotatable polygon mirror 204 is stabilized at the predetermined period.

Further, the top sensor 150 sends, to the engine controller 205, a recording material detection signal 210 generated by detecting a leading end of the recording material S (hereinafter, this signal is referred to as a TOP signal). On the basis of the BD signal 207 and the TOP signal 210, the engine controller 205 causes the image controller 212 to input the video signal 214 to the laser controller 201, so that the engine controller 205 causes the laser controller 201 to perform an exposure operation depending on the video signal 214.

### 6. Transfer Device

The transfer roller 5 is disposed in contact with the photosensitive drum 1 and constitutes the transfer device as a transfer means. The transfer roller 5 comprises a core metal and an elastic layer formed of an electroconductive foam rubber having an elastic characteristic. For example, an ion conductive material or carbon black is used as a method imparting electroconductivity, and EPDM, NBR, or hydrin is used as a material of the foam rubber. The transfer roller 5 is pressed toward the photosensitive drum 1, and forms a transfer portion (transfer nip) (transfer position N) where the photosensitive drum 1 and the transfer roller 5 are in contact with each other. The transfer roller 5 is rotated at a peripheral speed, substantially the same as that of the photosensitive drum 1, by a frictional force in the transfer position N with the rotation of the photosensitive drum 1 in the rotational direction R1. In the embodiment 1, as the transfer roller 5, a transfer roller prepared in a diameter of 15 mm by forming a foam rubber of principally made of NBR on a core metal of SUS having a diameter of 5 mm is used.

The recording material S is conveyed to the transfer position N between the transfer roller 5 and the photosensitive drum 1. The toner image formed on the photosensitive drum 1 is transferred in the transfer position N onto the recording material S nipped and conveyed by the photosensitive drum 1 and the transfer roller 5. During the transfer, to the transfer roller 5, by the transfer power source 14 (FIG. 2), a predetermined transfer voltage which is a DC voltage of the opposite polarity (positive polarity in the embodiment 1) to the normal charge polarity (normal polarity) of the toner is applied. To the back surface of the recording material S, an electric charge of the opposite polarity to the charge polarity of the toner is imparted, whereby the toner image is transferred onto the front surface of the recording material S.

In the embodiment 1, in a region (region from a position of 2 mm from a recording material leading end to a position of 2 mm from a recording material trailing end) developing voltage conveyance (hereinafter, referred to also as sheet passing), to the transfer roller 5, a voltage of about +1 kV is applied for performing constant-current control at 15 μA. By this, the toner image formed on the photosensitive drum 1 is transferred onto the recording material S. In a region (region before the position of 2 mm from the recording material leading end or after the position of 2 mm from the recording material trailing end) other than the region during the sheet passing, to the transfer roller 5, a voltage of about +0.6 kV is applied for performing constant-current control at 10 μA. A change in these voltages is made by controlling a timing or a voltage change amount by input of a signal indicating a detection result of the top sensor 150 to the engine controller 205.

### 7. Print Sequence

Next, the print sequence (print operation, job) in the embodiment 1 will be described.

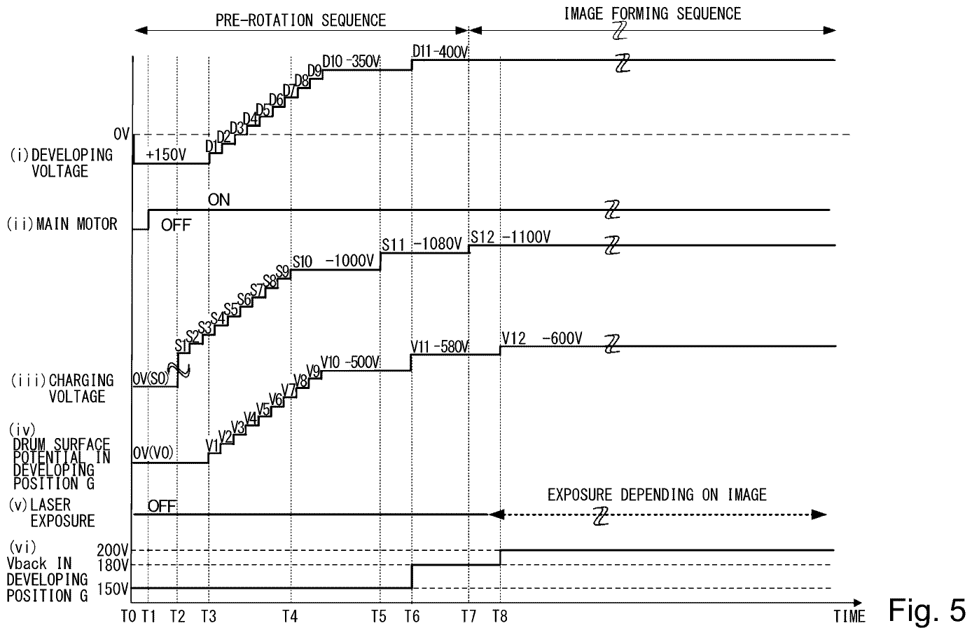

FIG. 5 is a timing chart of a print sequence in the embodiment 1. In FIG. 5, progressions of the developing voltage, the charging voltage, operations of the main motor 10 and the exposure device 3 (laser exposure), and the surface potential of the photosensitive drum 1 in the print sequence are shown. Specifically, (i) of FIG. 5 shows the developing voltage (V), (ii) of FIG. 5 shows the operation (ON or OFF) of the main motor 10, (iii) of FIG. 5 shows the charging voltage (V), (iv) of FIG. 5 shows a surface potential (V) (drum surface potential) of the photosensitive drum 1 in the developing position G, (v) of FIG. 5 shows a state (OFF or exposure to light depending on the video signal 214) of the laser light from the exposure device 3, and (vi) of FIG. 5 shows Vback (=|Vd−Vdc|). In (i) to (vi) of FIG. 5, the abscissa represents a time. Operations described below in the print sequence are controlled by the engine controller 205. Vback is an absolute value of a difference between the developing voltage (Vdc) and the surface potential (Vd) of the photosensitive drum 1. In the following description, Vback=|−150 V| is described simply as Vback=150 V, or the like.

Incidentally, in the embodiment 1, each of the charging voltage and the developing voltage is subjected to constant-voltage control, and in the timing chart, the charging voltage and the developing voltage are target values (target voltages) of the charging voltage and the developing voltage, respectively. Incidentally, the constant-voltage control is control such that output of the power source is adjusted so that a voltage applied to an application object becomes substantially constant at the target voltage. Further, in the timing chart, the surface potential of the photosensitive drum 1 shows a potential in the developing position G. However, in this embodiment, as described above, the natural attenuation of the surface potential of the photosensitive drum 1 during movement of the surface of the photosensitive drum 1 from the charging position C to the developing position G is to the negligible degree. Further, in the timing chart, “T0”, “T1”, “T2”, and the like represent timings. Further, for convenience, magnitudes (high/low) of the voltages and the potential refer to magnitudes (high/low) when the voltages and the potential are compared in terms of absolute values, unless otherwise particularly specified.

The print sequence consists of a “pre-rotation sequence (pre-rotation operation)”, an “image forming sequence (image forming operation)”, and a “post-rotation sequence (post-rotation operation)”. The pre-rotation sequence is control such that for image formation, drive of the image forming portion is started and the surface potential of the photosensitive drum 1 is raised (increased) from 0 V to the dark potential Vd which is the surface potential. The pre-rotation operation executed in the pre-rotation sequence can also be said as a preparation operation. In the image forming sequence, after the potential of the surface of the photosensitive drum 1 is raised to the dark potential Vd, a part of the surface of the photosensitive drum 1 is subjected to laser exposure corresponding to the image signal. Further, the image forming sequence is a sequence such that the surface potential of the photosensitive drum 1 is dropped to the light potential Vl which is the surface potential of the photosensitive drum 1 for image formation. The post-rotation sequence is a sequence such that the rotation of the image forming portion is stopped after the image formation and thus the image forming operation is ended. The post-rotation sequence is control such that the surface potential of the photosensitive drum 1 after the image formation is lowered from the dark potential Vd to substantially 0 V. The post-rotation sequence in the embodiment 1 has not a feature of the present disclosure, and conventionally well-known control can be used. Therefore, detailed description thereof will be omitted.

As shown in (vi) of FIG. 5, in the embodiment 1, the dark potential Vd is −600 V, and the light potential Vl is −250 V. Further, in the embodiment 1, the engine controller 205 carries out control so that Vback as a third back contrast in the first half of the pre-rotation sequence is maintained at 150 V. Further, engine controller 205 carries out control so that Vback as a second back contrast in the second half of the pre-rotation sequence is maintained at 180 V. Further, the engine controller 205 carried out control so that Vback as a first back contrast in the image forming sequence is maintained at 200 V. By this, a magnitude relationship between these back contrasts satisfy: (third back contrast) <(second back contrast)<(first back contrast). By this, a memory trace in a portion where the transfer roller 5 and the photosensitive drum 1 contact each other can be suppressed. Incidentally, the memory trace will be described later.

### Pre-Rotation Sequence

First, the pre-rotation sequence will be described. When the engine controller 205 acquires the print signal from the host computer 300, application of the developing voltage to the developing roller 42 by the developing power source 50 is started (T0). In the embodiment 1, as described above, in the post-rotation sequence, the surface potential of the photosensitive drum 1 is dropped to approximately 0 V. In the pre-rotation sequence, in order to maintain the Vback as the third back contrast at 150 V during actuation of the photosensitive drum 1, in a timing T0, application of a developing voltage of +150 V which is the developing voltage of the positive polarity is started.

The high-voltage power source takes a time required for an output voltage to rise up to a target voltage. For that reason, after the application of the developing voltage is started and then a time required until rising of the developing voltage is ended has elapsed, the main motor 10 is started (ON), so that rotation of the photosensitive drum 1 is started (T1). The number of rotations is controlled so as to become a predetermined number of rotations, on the basis of the above-described BD signal 207. The main motor 10 takes a time required for the number of rotations up to a target number of rotations. For that reason, after the main motor 10 is started and then a time required until rising of the number of rotations of the main motor 10 up to the target number of rotations is ended has elapsed, application of a first charging voltage S1 to the charging roller 2 by the charging power source 11 is started (T2).

The charging voltage is controlled so as to be raised in a step form (stepwise) from the first charging voltage S1 to a tenth charging voltage S10 with a fluctuation width (change width) of 50 V per 30 ms. Incidentally, control such that the voltage (or a potential) is raised in the step form (stepwise) in such a manner is also referred to as “stepwise rising control”. Here, (stepwise) rising of the voltage in the step form with the fluctuation width of 50 V per 30 ms refers to that a target voltage in each stage changed by 50 V is retained for 30 ms. A retention time of the target voltage in each stage is set so that an output voltage of the high-voltage power source becomes a target voltage in at least a part of a period of each stage. In the embodiment 1, the first charging voltage S1 at the timing (T2) of a start of the stepwise rising control of the charging voltage is −550 V, and the tenth charging voltage S10 in the final stage of the stepwise rising control of the charging voltage is −1000 V. Further, as described above, the fluctuation width of the charging voltage per stage is 50 V. Incidentally, a charging voltage (OFF, 0V) from the timing T0 when the pre-rotation sequence is started to the timing T2 when the stepwise rising control of the charging voltage is started is S0.

Further, the charging voltage is switched in the following manner in order to maintain the Vback as the second back contrast at 180 V in the second half of the pre-rotation sequence. After the charging voltage is raised up to the tenth charging voltage S10, the charging voltage is changed to an eleventh charging voltage S11 (−1080 V) at a predetermined timing (T5). Further, the eleventh charging voltage S11 is maintained to a timing (T7) before the image forming sequence. Although a retention period of the eleventh charging voltage S11 from T6 to T7 will be specifically described later in a section of “Effect”, it is desirable that on the surface of the photosensitive drum 1, a length of a region, in a circumferential direction, where the eleventh charging voltage S11 is applied is longer than a length corresponding to one-full circumference of the transfer roller 5. For this reason, in the embodiment 1, the length of the above-described region is a length corresponding to two-full circumferences. Incidentally, the length corresponding to the one-full circumference is a length of a region as an outermost surface region of the transfer member.

The surface potential of the photosensitive drum 1 is retained at 0V until the timing T2 when the application of the charging voltage is started. After the stepwise rising control of the charging voltage is started, the surface potential of the photosensitive drum 1 becomes large from a first surface potential V1 to a tenth surface potential V10 in a step form (stepwise) correspondingly to the charging voltage. In the embodiment 1, the first surface potential V1 is −50 V correspondingly to the first charging voltage S1 at the time of the start of the stepwise rising control of the charging voltage, and the tenth surface potential V10 is −500 V correspondingly to the tenth charging voltage S10 in the final stage of the stepwise rising control of the charging voltage. Further, the fluctuation width per stage of the surface potential of the photosensitive drum 1 is 50 V. That is, the surface potential of the photosensitive drum 1 is raised from the first surface potential V1 to the tenth surface potential V10 in the step form (stepwise) with the fluctuation width of 50 V per 30 ms.

Here, in the embodiment 1, a discharge start voltage (discharge threshold) between the photosensitive drum 1 and the charging roller 2 is about 500 V. Incidentally, the surface potential (0V) of the photosensitive drum 1 from the start of the pre-rotation sequence until the stepwise rising control of the surface potential of the photosensitive drum 1 is defined as V0. Further, the surface potential of the photosensitive drum 1 becomes an eleventh surface potential V11 (−580 V) corresponding to the eleventh charging voltage S11 (T6).

The developing voltage is controlled so that the Vback as the third back contrast is first maintained at 150 V in the developing position G where the photosensitive drum 1 and the developing roller 42 contact each other. In the embodiment 1, at a timing when the rising control of the developing voltage is started, the developing voltage is a first developing voltage D1 (+100 V), and at the time of an end of the rising control, the developing voltage becomes a tenth developing voltage D10 (−350 V). For that reason, the rising control of the developing voltage is carried out so that a voltage fluctuation width per step becomes 50 V.

Further, in order to maintain the Vback as the second back contrast at 180 V in the second half of the pre-rotation sequence, the developing voltage is raised up to the tenth developing voltage D10, and thereafter is changed to an eleventh developing voltage D11 (−400 V) at a predetermined timing (T6). As a result, in combination with the above-described switching of the charging voltage to the eleventh charging voltage S11, the Vback is changed to 180 V as the second back contrast, and then is maintained. Thus, is the pre-rotation sequence, with the timing T6 as a boundary, the sequence is divided into the first half in which the Vback is controlled to 150 V and the second half in which the Vback is controlled to 180 V.

A switching timing between the pre-rotation sequence and the image forming sequence will be described. This switching timing is T7 and corresponds to a trailing end position of a region where the surface potential of the photosensitive drum 1 becomes the surface potential V11 under application of the eleventh charging voltage S11 to the surface of the photosensitive drum 1 in the charging position C. When this trailing end position reaches the transfer position N, a leading end portion of the recording material S reaches the transfer position N. In the embodiment 1, the timing T7 is a timing when a region of the photosensitive drum 1 positioned in the transfer position N when a position of 2 mm from a leading end of the recording material S on which the toner image is to be printed in the transfer position N after the pre-rotation sequence reaches the transfer position N is in the charging position C by being traced back timewisely to the charging position C. That is, a timing when a portion (contact position) of the photosensitive drum 1 contacting the position of 2 mm from the leading end of the recording material S in the transfer position N during the image forming sequence is positioned in the charging position C in a direction opposite to the rotational direction R1 in FIG. 1 is the timing T7. At the switching timing T7 between the pre-rotation sequence and the image forming sequence, it is desirable that when the surface position of the photosensitive drum 1 positioned in the charging position C at that timing reaches the transfer position N, the leading end portion of the recording material S also reaches the transfer position N. Further, it is desirable that the surface position of the photosensitive drum 1 is positioned in front of a leading end of an image to be formed on the recording material S (positioned on a more leading end side of the recording material S). Incidentally, this will be specifically described later in the section of “Effect”.

### Image Forming Sequence

Next, the image forming sequence will be described. In the embodiment 1, as described above, during the image formation, the surface potential of the photosensitive drum 1 is −600 V which is the dark potential optimum for the image formation. For that reason, during the image formation, a charging voltage applied to the charging roller 2 by the charging power source 11 is changed from the eleventh charging voltage S11 (−1080 V) to a twelfth charging voltage S12 (−1100 V) at the timing T7. On the other hand, during the image formation, a developing voltage of −400 V is applied to the developing roller 42 by the developing power source 50. That is, in the embodiment 1, during the image formation, the Vback is changed to 200 V as the first back contrast.

Further, the engine controller 205 controls, as described above, the motor 208 so that the number of rotations of the rotatable polygon mirror 204 becomes the predetermined number of rotations. That is, the engine controller 205 adjusts the driving signal 220 so that an acquiring period of the BD signal sent from the BD 206 becomes constant, and subjects the number of rotations of the motor 208 to feed-back control. Then, when the engine controller 205 receives the print signal from the host computer 300, the engine controller 205 starts a feeding operation of the recording material S by controlling the feeding roller 8 so as to rotate after a lapse of a predetermined time.

The recording material S is conveyed from the cassette 7 toward the conveying roller 9 along the conveying passage. When the recording material S is detected by the top sensor 150 provided in the conveying passage in the neighborhood of a side downstream of the conveying roller 9 with respect to the conveying direction of the recording material S, a TOP signal 210 is sent from the top sensor 150 to the image controller 212 by way of the engine controller 205. When the image controller 212 receives the TOP signal 210, the image controller 212 sends, to the laser controller 201, the video signal 214 synchronized with the TOP signal 210 after a lapse of a predetermined time. By this, the image controller 212 performs synchronization between the image and the recording material S with respect to a sub-scan direction (the conveying direction of the recording material S). Further, the image controller 212 sends the video signal 214 to the laser controller 201 in synchronism with the BD signal 207, so that the image controller 212 performs synchronization between the image and the recording material S with respect to a main scan direction (a direction perpendicular to the conveying direction of the recording material S).

When the image controller 212 receives the image signal (image data), corresponding to the output image, from the host computer 300, the image controller 212 performs appropriate image processing and then converts the processed image signal into the video signal 214, and synchronizes the video signal 214 with the TOP signal 210 and the BD signal 207 and then sends the video signal 214 to the laser controller 201. The laser controller 201 controls ON and OFF of the laser light source 200 in accordance with the video signal 214 sent from the image controller 212. The surface potential of the photosensitive drum 1 is controlled to the dark potential Vd of −600 V until the photosensitive drum surface is subjected to the laser light exposure. On the other hand, the surface potential of the photosensitive drum 1 becomes the light potential Vl of −250 V after the photosensitive drum surface is subjected to the laser light exposure. When the surface of the photosensitive drum 1 passes through the developing portion G, the toner electrically urged is transferred from the surface of the developing roller 42 (−400 V) onto the image portion (portion of the light potential Vl) of the surface of the photosensitive drum 1, so that the toner image is formed on the surface of the photosensitive drum 1 corresponding to a laser exposure portion. The image formation as described above is started from a leading end portion of the image with respect to the conveying direction (a movement direction of the surface of the photosensitive drum 1), and is continued to a trailing end portion of the image with respect to the conveying direction. Further, the image formation as described above is carried out by the number of times corresponding to the number of printed sheets.

### 8. Effect

### Memory Trace

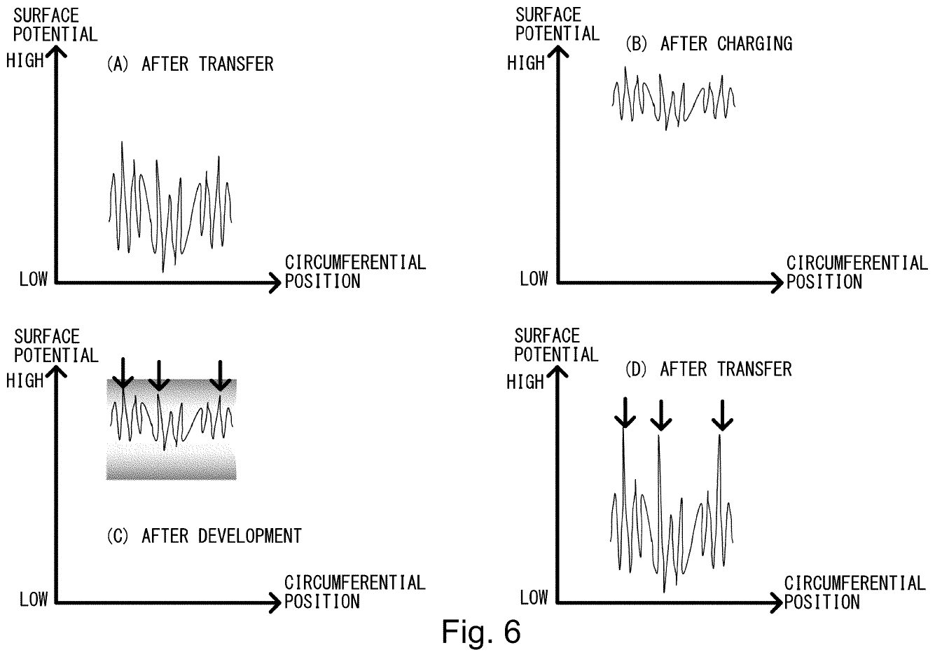

Suppression of the memory trace, which is an effect of the embodiment 1, in a portion of contact between the transfer roller 5 and the photosensitive drum 1 will be described. First, for the memory trace of the contact portion (transfer position N) between the transfer roller 5 and the photosensitive drum 1, an occurrence mechanism will be described. This memory trace is due to occurrence of surface potential non-uniformity of the photosensitive drum 1 corresponding to the contact portion between the transfer roller 5 and the photosensitive drum 1. In FIG. 6, a microscopic surface potential of the photosensitive drum 1 in each of positions of the photosensitive drum 1 during the pre-rotation sequence in a conventional example is shown. Incidentally, in each of graphs of FIG. 6, an abscissa represents the position of the photosensitive drum 1 with respect to a circumferential direction of the surface of the photosensitive drum 1, and an ordinate represents the surface potential of the photosensitive drum 1. Incidentally, the positions of the photosensitive drum 1 with respect to the circumferential direction of the surface of the photosensitive drum 1 are common to (A) to (D) of FIG. 6.

In FIG. 6, (A) shows the microscopic surface potential of the photosensitive drum 1 in the circumferential position after the transfer. In the transfer position N, to the transfer roller 5, a transfer voltage of the opposite polarity (the positive polarity in the embodiment 1) to the charge polarity (the negative polarity in the embodiment 1) of the surface potential of the photosensitive drum 1 is applied, so that a transfer current flows through the photosensitive drum 1 and thus an absolute value of the surface potential of the photosensitive drum 1 becomes small. At this time, the transfer roller 5 is a foam rubber, and therefore, the transfer current in the transfer position N microscopically flows non-uniformly, with the result that the surface potential of the photosensitive drum 1 after the transfer is in a state in which a variation thereof is larger than that compared with the state before the charging.

In FIG. 6, (B) shows the microscopic surface potential of the photosensitive drum 1 in the circumferential position after the charging. In the charging position C, the potential is enhanced by electric discharge from the charging roller 2, so that although the variation in potential becomes small, the variation potential does not become zero. That is, the surface potential of the photosensitive drum 1 does not become uniform even when the surface of the photosensitive drum 1 is subjected to the charging processing by the charging roller 2.

In FIG. 6, (C) shows the microscopic surface potential of the photosensitive drum 1 in the circumferential position after the development. Gradation in the background of the graph shows a state in which the electrostatic latent image is developed with the toner. In the graph after the development, the potential formed in (B) of FIG. 6 is substantially maintained as it is. Here, in the developing position G, there are portions where the potentials are high and low, and therefore, also as regards the Vback, a microscopically large portion and a microscopically small portion thereof generate. In the case where the Vback is large, a reverse fog microscopically occurs, and in the case where the Vback is small, a normal fog occurs. Positions indicated by arrows in the graph of (D) of FIG. 6 show positions where the reverse fog occurs.

In FIG. 6, (D) shows the microscopic surface potential of the photosensitive drum 1 in the circumferential position after the transfer. As described with reference to (A) of FIG. 6, although the transfer current flows through the photosensitive drum 1 and the absolute value of the surface potential of the photosensitive drum 1 becomes small, here, as regards the portion where the reverse fog microscopically occurs, the fog toner constitutes a resistor and obstructs the flow of the transfer current. Due to this, the surface potential of the photosensitive drum 1 in this portion is not dropped compared with those in other portions (i.e., cannot be made small in terms of the absolute value), and in addition, the above-described portion is a portion where the surface potential was originally high, so that regions in which the surface potentials are microscopically higher (larger in absolute value) are formed (arrow portions in (D) of FIG. 6). Thereafter, the rotation of the photosensitive drum 1 is continued, and thus processes (B), (C), and (D) are repetitively continued, so that a phenomenon such that compared with other regions of the photosensitive drum 1, the portions (regions) in which the surface potentials are high (the arrow portions in FIG. 6) are continuously amplified occurs.

The portions which generate in the above-described manner and in which the surface potentials of the photosensitive drum 1 are microscopically high are visualized as image defects such that an image density when for example, an intermediary-tone image such as a half-tone image is formed in a subsequent image forming operation does not becomes a desired density (i.e., results in portion where the image density locally becomes thin discretely). Then, after the recording material S reaches the transfer position N, the transfer roller 5 and the photosensitive drum 1 do not directly contact each other, and the microscopic non-uniformity of the transfer current as described with reference to (A) of FIG. 6 does not occur by way of the recording material S, so that this phenomenon is eliminated. As a result, for example, when the half-toner image is formed on a whole surface of the recording material S, a phenomenon such that the memory trace occurs from the leading end of the recording material S in a distance corresponding to one-full circumference of the photosensitive drum 1 (hereinafter, this phenomenon is referred to as a roughened image of one-full circumference of drum from (SH) leading end).

Further, due to the microscopical non-uniformity of the transfer current as described with reference to (A) of FIG. 6, the reverse fog and the normal fog which were described with reference to (C) of FIG. 6 microscopically occur. In the portion of the reverse fog, a high potential state is continuously amplified, whereas in the portion of the normal fog, a flow of the transfer current of a microscopically low potential part thereof is obstructed by a subsequent fog toner and thus the potential is not completely dropped microscopically (i.e., is shifted toward a high potential state), with the result that these portions are directed to a cancel-out direction. From this, in the portion where the normal fog occurred (hereinafter, this portion is referred to as a normal fog portion), a phenomenon such that the portion where the potential is microscopically low is continuously amplified does not occur.

In view of this mechanism, an effect of the embodiment 1 will be described. In view of the above-described mechanism, the Vback is lowered, so that the lowered Vback contributes to suppression of the reverse fog particularly in the portion where the Vback is large (the arrow portions shown in (C) of FIG. 6). As in the embodiment 1, relative to the Vback during the image forming sequence, the Vback is made smaller as toward a front side of the image forming sequence (as the sequence is executed earlier than the image forming sequence) such that during the pre-rotation sequence, the Vback is set to 150 V in the first half and is set to 180 V in the second half. By this, it is possible to suppress the reverse fog and amplification of the high surface potential state of the photosensitive drum 1 due to the reverse fog.

Here, it is desirable that the switching timing T7 between the pre-rotation sequence and the image forming sequence is such that when the surface position of the photosensitive drum 1 charged in the charging position C reaches the transfer position N at the timing by rotation thereof, the leading end portion of the recording material S also reaches the transfer position N. In the case where when the surface position of the photosensitive drum 1 charged in the charging position C reaches the transfer position N at the timing by rotation thereof, the leading end portion of the recording material S does not reach the transfer position N yet, the following phenomenon occurs. That is, in this case, at a timing when the recording material S does not reach the transfer position N, a region of the photosensitive drum 1 in which the Vback is 200 V reaches the transfer position N.

The timing T7 comes with a timing when the recording material S does not reach the photosensitive drum 1 means that the region of the photosensitive drum 1 where the Vback is switched to 200 V is in the transfer position N at the timing when the recording material S does not reach the photosensitive drum 1. At this time, a surface in which there is no recording material S between the transfer roller 5 and the photosensitive drum 1 is formed, so that the memory trace in the portion where the transfer roller 5 and the photosensitive drum 1 were in contact with each other is liable to occur.

Further, the switching timing T7 between the pre-rotation sequence and the image forming sequence may desirably be the following timing. That is, it is desirable that at the timing, when the surface position of the photosensitive drum 1 charged in the charging position C reaches the transfer position N, the surface position of the photosensitive drum 1 is positioned in front of (earlier in time, on a recording material leading end side) than a leading end of an image to be formed on the recording material S. This is because when the image is formed in the region of the photosensitive drum 1 where the Vback is switched to 200 V during the image formation, there is a case where the image density is changed.

### Backside Contamination

Next, suppression of backside contamination which is another effect of the embodiment 1 will be described. First, an occurrence mechanism of the backside contamination will be described. In the portion of the reverse fog described above in the mechanism of the memory trace in the portion where the transfer roller 5 and the photosensitive drum 1 were in contact with each other, the high potential state is continuously amplified, whereas the normal fog is in the cancel-out direction. From this, description that the phenomenon of the continuous amplification does not occur in the normal fog portion was made. However, the normal fog portion has the same polarity as the charge polarity of the toner image during the image formation, so that a phenomenon that the toner image is transferred onto the transfer roller 5 in the transfer position N occurs. Incidentally, the reverse fog is not transferred electrically onto the transfer roller 5. The normal fog toner transferred on the transfer roller 5 results in the backside contamination when the recording material S reaches the transfer position N.

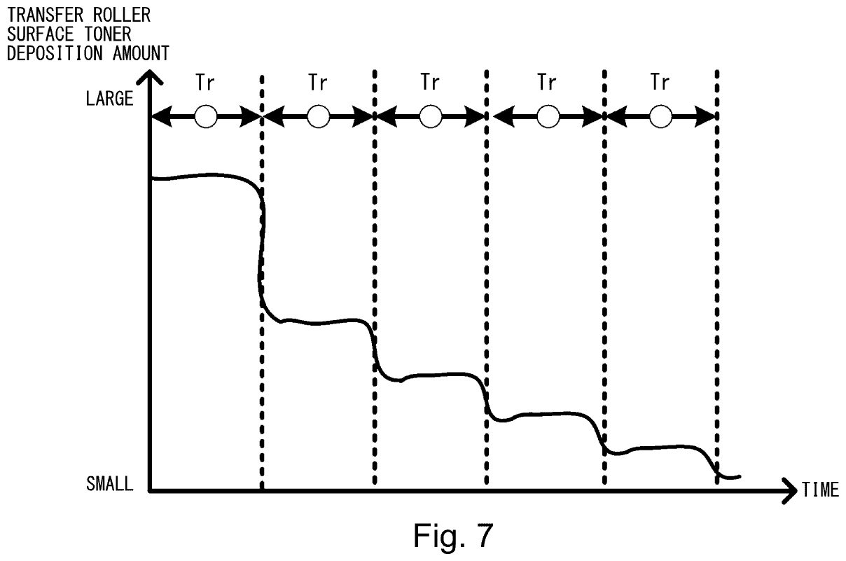

In FIG. 7, time progression of an amount of the toner deposited on the surface of the transfer roller 5 after the normal fog toner is supplied in an amount corresponding to one-full circumference of the transfer roller 5 in the pre-rotation sequence of the image forming apparatus in the conventional example is shown. In a graph of FIG. 7, the abscissa represents a time, and the ordinate represents a deposition amount of the toner on the surface of the transfer roller 5. Further, a double-pointed arrow indicates a period Tr in which the transfer roller 5 rotates one turn.

When the normal fog toner is deposited on the transfer roller 5 and then rotation of the transfer roller 5 and application of the transfer voltage are continued as they are, the following phenomenon occurs. A part of the normal fog toner becomes toner (reversely charged toner) charged to the opposite polarity (positive polarity in the embodiment 1) to the normal polarity of the toner by the influence of an electric field formed by a potential difference between the transfer voltage and the surface potential of the photosensitive drum 1. Further, a part of the normal fog toner is moved further toward the core metal side with application of the transfer voltage. As a result, as shown in FIG. 7, every rotation of the transfer roller 5 by one-full circumference, the amount of the toner deposited on the surface of the transfer roller 5 is decreased with time.

In view of this mechanism, the effect of the embodiment 1 will be described. By the above-described mechanism, even when the normal fog toner generated in the first half of the pre-rotation sequence is deposited on the transfer roller 5, thereafter there is room for a decrease thereof in amount. However, when the normal fog toner generated in the final stage of the pre-rotation sequence is deposited on the transfer roller 5, thereafter there is no room for the decrease thereof in amount, and therefore, the normal fog toner is liable to appear as the backside contamination. Therefore, as in the embodiment 1, relative to 200 V which is the Vback during the image forming sequence in the pre-rotation sequence, the Vback is set smaller as toward a front side in this embodiment such that the Vback in the first half is 150 V and the Vback in the second half is 180 V. By this, it is possible to suppress an occurrence of the backside contamination due to the normal fog.

Here, it is desirable that a Vback forming section in the second half of the pre-rotation sequence is a rotation time of the photosensitive drum 1 longer than a length corresponding to one-full circumference of the transfer roller 5. This is because as described with reference to FIG. 7, the toner deposited on the surface of the transfer roller 5 is decreased every rotation of the transfer roller 5 by one-full circumference. For this reason, it is effective as alleviation of the backside contamination that in the second half of the pre-rotation sequence, the Vback at which the normal fog is harder to generate than in the first half of the pre-rotation sequence is formed in a length longer than length corresponding to the one-full circumference of the transfer roller 5.

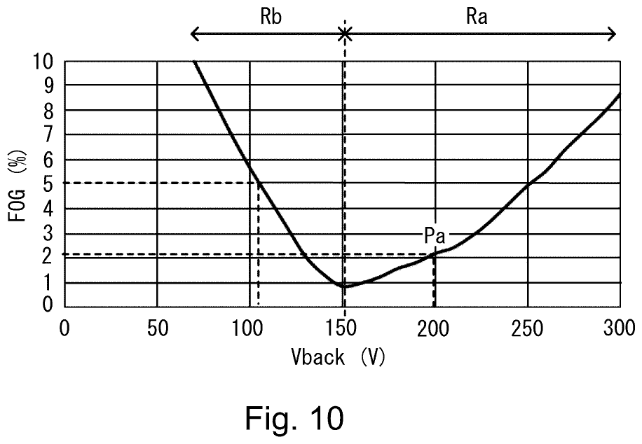

FIG. 10 is a graph showing an example of a relationship between the Vback (V) and a fog toner amount (%). In FIG. 10, the abscissa represents the Vback, and the ordinate represents the fog toner amount.

The fog toner amount was acquired in a method such that non-image portion T on the photosensitive drum 1 is transferred onto a Myler type by taping and the tape is stuck to reference paper, and thereafter, a density thereof is measured by a reflection density meter (“TC-6DS/A”, manufactured by Tokyo Denshoku Co., Ltd.). By using this method, a graph was prepared in the following manner. In the image forming apparatus 100, an image forming operation (formation of a solid white image) was performed. The image forming operation of the image forming apparatus 100 is intentionally stopped at a predetermined timing and then the amount of the toner on the photosensitive drum 1 was measured by the above-described taping method. This measurement was repeated while changing the Vback, so that the graph was prepared. In the graph of FIG. 10, the fog (toner) amount where the Vback is 200 V is about 2% (first deposition amount) (Pa in FIG. 10). A value of 200 V for the Vback is the value of the first potential difference during the image forming sequence in the embodiment 1, the fog generating at this first potential difference is the above-described reverse fog, and the fog amount becomes larger in a region of monotonical increase, i.e., with a larger Vback, and becomes smaller with a smaller Vback.

As shown in FIG. 10, the relationship between the Vback and the fog toner amount provides a graph of a downward projected shape having a minimum value of the fog toner amount. In the graph, a region in which the fog toner amount increases with a larger Vback is defined as a region Ra, and a region in which the fog toner amount increases with a smaller Vback is defined as Rb. In the region Ra, a potential difference larger than Vback=200 V which is the first potential difference is referred to as a fourth potential difference, and a potential difference smaller than Vback=200 V which is the first potential difference is referred to as a fifth potential difference. Further, the amount (2%) of the fog toner generating at Vback=200 V which is the first potential difference is the first deposition amount. Further, the amount of the fog toner generating at the fourth potential difference (Vback>200 V in Ra) is referred to as a second deposition amount, and the amount of the fog toner generating at the fifth potential difference (Vback 21 200 V in Ra) is referred to as a third deposition amount. Thus, the second deposition amount becomes larger than the first deposition amount, and the third deposition amount becomes smaller than the first deposition amount. Incidentally, the first deposition amount can also be said as a deposition amount per unit area of the toner deposited in a region in which the potential becomes a non-image portion potential by the first potential difference, and the second deposition amount can also be said as a deposition amount per unit area of the toner deposited in a region in which the potential becomes a non-image portion potential by the fourth potential difference. In addition, the third deposition amount can also be said as a deposition amount per unit area of the toner deposited in a region in which the potential becomes a non-image portion potential by the fifth potential difference.

As described above with reference to (B) of FIG. 6, the surface potential of the photosensitive drum 1 does not become uniform even when the surface of the photosensitive drum 1 is subjected to the charging processing by the charging roller 2. From study by the present inventors, it is assumed that the surface potential of the photosensitive drum 1 has a variation such that the surface potential microscopically exceeds 50 V at the maximum. When the Vback used in the first half of the pre-rotation sequence is 150 V, as is understood from FIG. 10, it is considered that the fog on the photosensitive drum generates in an amount microscopically exceeding 5% at the maximum. This is because it is considered that there is a region in which the Vback is microscopically below 100 V at the minimum and that the fog is generated in a fog amount corresponding thereto. Similarly, when the Vback used in the second half of the pre-rotation sequence is 180 V, it is considered that the fog on the photosensitive drum generates in an amount microscopically exceeding 2% at the maximum. When the Vback used in the image forming sequence is 200 V, it is considered that the fog on the photosensitive drum generates in an amount microscopically exceeding 1% at the maximum. That is, when the Vback during the image formation is 200 V, the backside contamination occurring at this potential difference is due to the above-described normal fog, the fog amount (by extension, an amount of the backside contamination) is in a monotonically decreasing region, i.e., when the Vback becomes large, the fog amount becomes small and the amount of the backside contamination also becomes small. Further, when the Vback becomes small, the fog amount becomes large and the amount of the backside contamination also becomes large.

That is, the backside contamination becomes as follows. In the region Ra, the amount of the backside contamination occurring at Vback=200 V which is the first potential difference is referred to as a fourth deposition amount. Further, the amount of the backside contamination occurring at the fourth potential difference (Vback>200 V in Ra) is referred to as a fifth deposition amount, and the amount of the backside contamination occurring at the fifth potential difference (Vback<200 V in Ra) is referred to as a sixth deposition amount. Then, the fourth deposition amount becomes larger than the fifth deposition amount, and the fourth deposition amount becomes smaller than the sixth deposition amount.

Incidentally, when the surface of the recording material on which the image is formed is the front surface (side) and the surface of the recording material opposite from the front surface is the back surface (side), the fourth deposition amount can also be said as a deposition amount per unit area of the toner deposited on the back surface by the first potential difference. Further, the fifth deposition amount can also be said as a deposition amount per unit area of the toner deposited on the back surface by the fourth potential difference, and the sixth deposition amount can also be said as a deposition amount per unit area of the toner deposited on the back surface by the fifth potential difference.

The amount of the backside contamination can also be measured by a measuring method similar to the measuring method of the fog toner amount. That is, in the image forming apparatus 100, the image forming operation of the image forming apparatus 100 during the printing is intentionally stopped at a predetermined timing, and the reflection density of the non-image forming surface (back surface) of the recording material S is measured by the reflection density meter (“TC-6DS/A”, manufactured by Tokyo Denshoku Co., Ltd.). The amount of the backside contamination can be acquired by measuring this value while changing the Vback.

Thus, by setting the Vback to 150 V in the first half of the pre-rotation sequence, 180 V in the second half of the pre-rotation sequence, and 200 V in the image forming sequence, the amount of the normal fog on the photosensitive drum in the second half of the pre-rotation sequence in which the normal fog is liable to have the influence on the backside contamination is microscopically suppressed. By this, the backside contamination of the recording material S can be suppressed.

Incidentally, in the embodiment 1, the Vback was changed to 150 V in the first half of the pre-rotation sequence, 180 V in the second half of the pre-rotation sequence, and 200 V in the image forming sequence. A difference between the Vback in the first half and the Vback in the second half in the pre-rotation sequence is Δ1=(180 V−150 V=) 30 V. Further, a difference between the Vback in the image forming sequence and the Vback in the second half of the pre-rotation sequence is Δ2=(200 V−180 V=) 20 V. When the difference Δ1 is a first difference and the difference Δ2 is a second difference, a magnitude relationship between the first difference Δ1 and the second difference Δ2 was Δ1>Δ2. Incidentally, in the embodiment 1, a setting of Δ1>Δ2 was made, but the present disclosure is not limited to this setting condition, and the magnitude relationship may preferably be appropriately set. For example, in the case where the transfer memory is severe, Δ1>Δ2 was set, but in the case where the backside contamination is severe, Δ1≥Δ2 may be set. Further, these relationships may also be appropriately changed depending on an environmental condition or an image forming mode change due to a change in paper size.

### 9. Effect Confirmation

A result of an image output experiment in which the effect of the embodiment 1 was confirmed will be described. The image output experiment was conducted for the embodiment 1, and comparison examples 1, 2, 3, and 4. In the embodiment 1, control was carried out so that the Vback as the third back contrast is maintained at 150 V in the first half of the pre-rotation sequence and so that the Vback as the second back contrast is maintained at 180 V in the second half of the pre-rotation sequence. Further, control was carried out so that the Vback as the back contrast is maintained at 200 V in the image forming sequence.

On the other hand, in the comparison example 1, control was carried out so that the Vback is maintained at 200 V in all of the first half and the second half of the pre-rotation sequence, and the image forming sequence. Further, in the comparison example 2, control was carried out so that the Vback is maintained at 150 V in the first half and the second half of the pre-rotation sequence and at 200 V in the image forming sequence.

Further, in the comparison example 3, control was carried out so that the Vback is maintained at 180 V in the first half and the second half of the pre-rotation sequence and at 200 V in the image forming sequence. Further, in the comparison example 4, control was carried out so that the Vback is maintained at 150 V in the first half of the pre-rotation sequence and at 200 V in the second half of the pre-rotation sequence and in the image forming sequence. Incidentally, constitutions and operations of the image forming apparatuses 100 of the comparison examples 1, 2, 3, and 4 are substantially the same as those of the image forming apparatus 100 of the embodiment 1 except for the above-described differences.

In the image forming apparatuses 100 of the embodiment 1 and the comparison examples 1 to 4, an image output experiment (print test of one sheet) was conducted, and evaluation was made by checking whether or not the above-described roughened image of one-full circumference drum from (sheet) leading end and the backside contamination occur. An evaluation condition is as follows. Printing was performed by using an A4-size sheet (“CS-068” (trade name), available from Canon Marketing Japan Inc.) (short edge feeding) as the recording material, a setting of 25% in image density of a whole surface half-tone image and 5 mm in margin, and a plain paper mode as a printing mode. In the image forming apparatus used in the experiment, a process speed is 250 mm/sec and a through put is 45 sheets per minute. An atmospheric environment in which the experiment was conducted is 23 °C in temperature and 50% RH in relative humidity. A result of the experiment is shown in table 1.

TABLE 1

| | PRFH*¹ | PRSH*² | IF*³ | R*⁴ | BSC*⁵ |
|---|---|---|---|---|---|
| EMB. 1 | 150 V | 180 V | 200 V | ◯ | ◯ |
| COMP. EX. 1 | 200 V | 200 V | 200 V | X | ◯ |
| COMP. EX. 2 | 150 V | 150 V | 200 V | ◯ | X |
| COMP. EX. 3 | 180 V | 180 V | 200 V | X | X |
| COMP. EX. 4 | 150 V | 200 V | 200 V | X | ◯ |

*¹“PRFH” is the pre-rotation (sequence) first half.
*²“PRSH” is the pre-rotation (sequence) second half.
*³“IF” is the image formation (image forming sequence).
*⁴“R” is the roughness (roughened image).
*⁵“BSC” is the backside contamination.

In the table 1, the Vback in the first half of the pre-rotation sequence is shown in a second column, the Vback in the second half of the pre-rotation sequence is shown in a third column, the Vback in the image forming sequence is shown in a fourth column, occurrence or non-occurrence of the roughed image of one-full circumference of drum from (sheet) leading end (hereinafter, referred to as roughness) is shown in a fifth column, and occurrence or non-occurrence of the backside contamination is shown in a sixth column. In the fifth column and the six column, “◯” shows that the roughness and the backside contamination did not occur, respectively, and “x” shows that the roughness and the backside contamination occurred, respectively.

In the embodiment 1, both the roughness and the backside contamination did not occur. On the other hand, in the comparison examples 1 to 4, either one or both of the roughness and the backside contamination occurred. This will be described in the following. In the comparison example 1, the roughness occurred. This is because due to the high Vback in the pre-rotation sequence, the reverse fog and a high surface potential state of the photosensitive drum 1 by the reverse fog and amplified and thus the memory trace of the portion of contact between the transfer roller 5 and the photosensitive drum 1 occurred.

Further, in the comparison example 2, the backside contamination occurred. This is because due to the low Vback in the pre-rotation sequence, the normal fog occurred and became apparent. Further, in the comparison example 3, the roughness and the backside contamination occurred. This is because the magnitude of the Vback in the pre-rotation sequence became a magnitude such that both the roughness and the backside contamination occur and thus both the roughness and the backside contamination became apparent. Further, in the comparison example 4, the roughness occurred. This is because due to the high Vback in the second half of the pre-rotation sequence, the reverse fog and the high surface potential state of the photosensitive drum 1 by the reverse fog are amplified and thus the memory trace of the portion of contact between the transfer roller 5 and the photosensitive drum 1 occurred.

Thus, in a state in which the transfer voltage is applied in the case where the operation is shifted from the non-image forming operation to the image forming operation, the engine controller 205 as the controller controls the charging voltage and the developing voltage so as to satisfy the following relationship:

(First potential difference)>(Second potential difference)>(Third potential difference).

Here, the first back contrast is an example of the first potential difference which is a potential difference between the non-image portion potential and the developing voltage when the surface of the photosensitive drum is positioned in the developing position before being positioned in the transfer position when the recording material is nipped between the transfer roller and the photosensitive drum. The second back contrast is an example of the second potential difference which is a potential difference between the non-image portion potential and the developing voltage when the surface of the photosensitive drum is positioned in the developing position immediately before the leading end of the recording material reaches the transfer position and before the surface of the photosensitive drum providing the first potential difference passes through the transfer position. The third back contrast is an example of the third potential difference. The third potential difference is a potential difference between the non-image portion potential and the developing voltage when the surface of the photosensitive drum is positioned in the developing position before the surface of the photosensitive drum providing the second potential difference passes through the transfer position and when the recording material is not nipped between the transfer roller and the photosensitive drum. Incidentally, with respect to the rotational direction of the photosensitive drum, a position of the surface of the photosensitive drum contacting the leading end of the recording material when a position of 2 mm from the leading end of the recording material enters the transfer position is referred to as a contact position. That is, on the surface of the photosensitive drum, there is a region, where the toner image formed in the image forming sequence is carried, on a side upstream of the contact position with respect to the rotational direction of the photosensitive drum. Further, on the surface of the photosensitive drum, there is a region, where the potential difference becomes an associated back contrast in the pre-rotation sequence, on a side downstream of the contact position with respect to the rotational direction of the photosensitive drum.

Further, a length, with respect to the rotational direction of the photosensitive drum, of the surface of the photosensitive drum providing the second potential difference is longer than a peripheral length of the transfer roller. That is, as shown in (vi) of FIG. 5, a region of Vback=150 V (to T6) is longer in time than a region a Vback=180 V (T6 to T8), in other words, it can be said that the region of Vback=150 V is longer in distance than the region of Vback=180 V. As shown in FIG. 5, in the first half of the pre-rotation sequence in which Vback=150 V is set, control such that rising of the high voltages is made in a state in which the developing roller contacts the photosensitive drum is included, and therefore, it takes time until the respective high voltages reach target voltages. For this reason, it is meaningful that in the first half of the pre-rotation sequence, the Vback lower than the Vback in the second half of the pre-rotation sequence is set and thus an appropriate potential difference is formed.

As described above, according to the embodiment 1, the back contrast in the first half of the pre-rotation sequence is the third back contrast, the back contrast in the second half of the pre-rotation sequence is the second back contrast, and the back contrast in the image forming sequence is the first back contrast. At this time, a magnitude relationship of (Third back contrast)<(Second back contrast)<(First back contrast) is satisfied, whereby it is possible to suppress the memory trace of the portion where the transfer roller 5 and the photosensitive drum 1 contact each other.

As described above, according to the embodiment 1, it is possible to suppress an image defect occurring in the leading end of the recording material.

Next, another embodiment of the present disclosure will be described. Basic constitution and operation of an image forming apparatus of an embodiment 2 are the same as those of the image forming apparatus 100 of the embodiment 1. Accordingly, in the image forming apparatus of the embodiment 2, as regards elements having the same or corresponding functions or constitutions as those of the image forming apparatus 100 of the embodiment 1, detailed description will be omitted by adding thereto the same reference numerals or symbols as those in the embodiment 1.

### 1. Summary of Embodiment 2

In the embodiment 2, by switching the developing voltage in a lower direction from the first half to the second half of the pre-rotation sequence and then to the image forming sequence, for the Vback, a magnitude relationship satisfy: (third back contrast)<(second back contrast)<(first back contrast) is established. By this, a method in which the memory trace of the portion of contact between the transfer roller and the photosensitive drum 1 is suppressed is employed.

### 2. Print Sequence

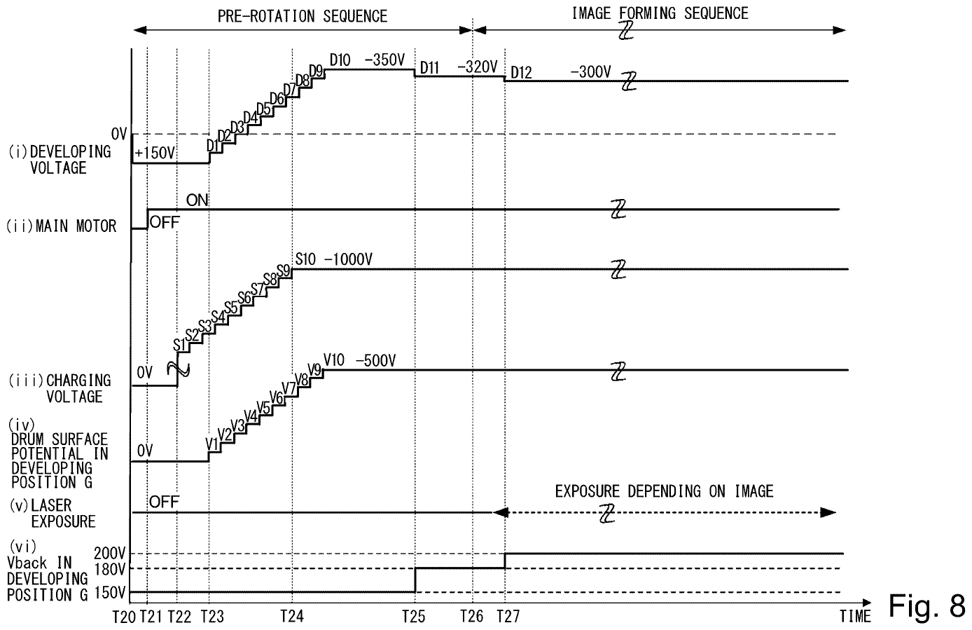

FIG. 8 is a timing chart of a print sequence in the embodiment 2. In the embodiment 2, the dark potential Vd is −500 V, and the light potential Vl is −150 V. In a graph of FIG. 8, (i) to (vi) are similar to (i) to (vi) of the graph of FIG. 5, respectively. Further, in FIG. 8, T20 to T27 show associated timings.

### Pre-Rotation Sequence

First, the pre-rotation sequence will be described. Control until a final stage (T20 to T24) of the stepwise rising control of the charging voltage is similar to that in the embodiment 1, and a tenth charging voltage S10 is set to −1000 V. In the embodiment 2, also during the image forming sequence, the charging voltage S10 is maintained.

The surface potential of the photosensitive drum 1 is set to −50 V as a first surface potential V1 correspondingly to the first charging voltage S1 at the timing of the start of the stepwise rising control of the charging voltage, and is set to −500 V as a tenth surface potential V10 correspondingly to the tenth charging voltage S10. In the embodiment 2, also during the image forming sequence, the tenth surface potential V10 is maintained.

The developing voltage is controlled so that Vback as the third back contrast is first maintained at 150 V. In the embodiment 2, at the timing T23 when rising control of the developing voltage is started, the developing voltage is a first developing voltage D1 (+100 V (=+150 V−50 V) and becomes a tenth developing voltage D10 (−350 V). For example, when the developing voltage became the tenth developing voltage D10, Vback=|−500 V−(−350 V)|=|−150 V| holds. That is, in the first half (before T25) of the pre-rotation sequence, Vback=150 V is maintained.

Further, in the second half of the pre-rotation sequence, the developing voltage is changed to an eleventh developing voltage D11 (−320 V) in a predetermined timing (T25), after being raised to tenth developing voltage D10, in order to maintain the Vback as the second back contrast at 180 V. Then, the developing voltage is maintained to a timing T27 in the image forming sequence. As a result, the Vback is changed to 180 V as the second back contrast and is maintained. For example, at the timing T25, Vback=|−500 V−(−320 V)|=|180 V| holds.

That is, in the second half (T25 and later) of the pre-rotation sequence, Vback=180 V is maintained.

Here, for a retention period of the eleventh developing voltage D11 from T25 to T27, it is desirable that in this retention period, a circumferential direction length of a surface region of the photosensitive drum 1 opposing the developing roller 42 surface is longer than a length corresponding to one-full circumference of the transfer roller 5. That is, it is desirable that in a period in which the eleventh developing voltage D11 is applied in the developing position, the circumferential direction length of the surface region of the photosensitive drum 1 contacting the developing roller 42 is longer than the length corresponding to the one-full circumference of the transfer roller 5. In the embodiment 2, the circumferential direction length of the surface region of the photosensitive drum 1 has a length corresponding to two-full circumferences of the transfer roller 5.

### Image Forming Sequence

Next, the image forming sequence will be described. In the embodiment 2, as described above, the tenth charging voltage S10 is maintained also during the image forming sequence (T26 and later). Further, the tenth surface potential V10 of the photosensitive drum 1 is also maintained. As regards the developing voltage, the eleventh developing voltage D11 is maintained to the timing T27, and thereafter, the developing voltage is switched to a twelfth developing voltage D12 (−300 V). As a result, Vback is changed to 200 V (=|−500 V−(−300 V)|=|−200 V| as the first back contrast, and then is maintained.

A switching timing of the timing T27 is a timing when the region of the photosensitive drum 1 positioned in the transfer position N where a position of 2 mm from the leading end of the recording material S on which the toner image is printed in the transfer position N after the pre-rotation sequence reaches the transfer position N is in the developing position G by being time widely traced back to the developing position. That is, a timing when a portion of the photosensitive drum 1 contacting the position of 2 mm from the leading end of the recording material S in the transfer position N during the image forming sequence is positioned in the developing position G in a direction opposite to the rotational direction R1 in FIG. 1 is the timing T27.

An effect in the embodiment 2 is similar to the effect in the embodiment 1 in principle, and therefore, will be omitted here. However, in the embodiment 2, the present disclosure is applied by switching only the developing voltage to a lower value, so that control becomes simple and the present disclosure can be applied without using large output in the charging power source or the developing power source. From this, an advantage such that the output of the charging power source or the developing power source is not required to be unnecessarily made large can be obtained.

As described above, the engine controller 205 as the controller controls the charging power source so that the charging voltage maintains a predetermined value when a boundary between the surface of the photosensitive drum providing the third potential difference and the surface of the photosensitive drum providing the second potential difference passes through the charging position. And, the engine controller 205 controls the charging power source so that the charging voltage maintains a predetermined value when a boundary between the surface of the photosensitive drum providing the second potential difference and the surface of the photosensitive drum providing the first potential difference passes through the charging position.

Further, the engine controller controls the developing power source so that an absolute value of the developing voltage becomes a value lower than that before the developing voltage is switched, when a boundary between the surface of the photosensitive drum providing the third potential difference and the surface of the photosensitive drum providing the second potential difference passes through the developing position. And, the engine controller 205 controls the developing power source so that an absolute value of the developing voltage becomes a value lower than that before the developing voltage is switched, when a boundary between the surface of the photosensitive drum providing the second potential difference and the surface of the photosensitive drum providing the first potential difference passes through the developing position.

As described above, the developing voltage is switched in a lower direction in terms of the absolute value from the first half to the second half of the pre-rotation sequence and then to during the image forming sequence. By this, for the Vback, the magnitude relationship of (third back contrast)<(second back contrast)<(first back contrast) is satisfied. For this reason, the memory trace of the portion where the transfer roller 5 and the photosensitive drum 1 contacted each other can be suppressed.

As described above, according to the embodiment 2, it is possible to suppress the image defect occurring in the leading end of the recording material.

Next, another embodiment of the present disclosure will be described. Basic constitution and operation of an image forming apparatus of an embodiment 3 are the same as those of the image forming apparatus 100 of the embodiment 1. Accordingly, in the image forming apparatus of the embodiment 3, as regards elements having the same or corresponding functions or constitutions as those of the image forming apparatus 100 of the embodiment 1, detailed description will be omitted by adding thereto the same reference numerals or symbols as those in the embodiment 1.

### 1. Summary of Embodiment 3

In the embodiment 3, the charging voltage is switched in a higher direction from the first half to the second half of the pre-rotation sequence and then to the image forming sequence. By this, for the Vback, a magnitude relationship satisfy: (third back contrast)<(second back contrast)<(first back contrast) is established. For this reason, a method in which the memory trace of the portion of contact between the transfer roller and the photosensitive drum 1 is suppressed is employed.

### 2. Print Sequence

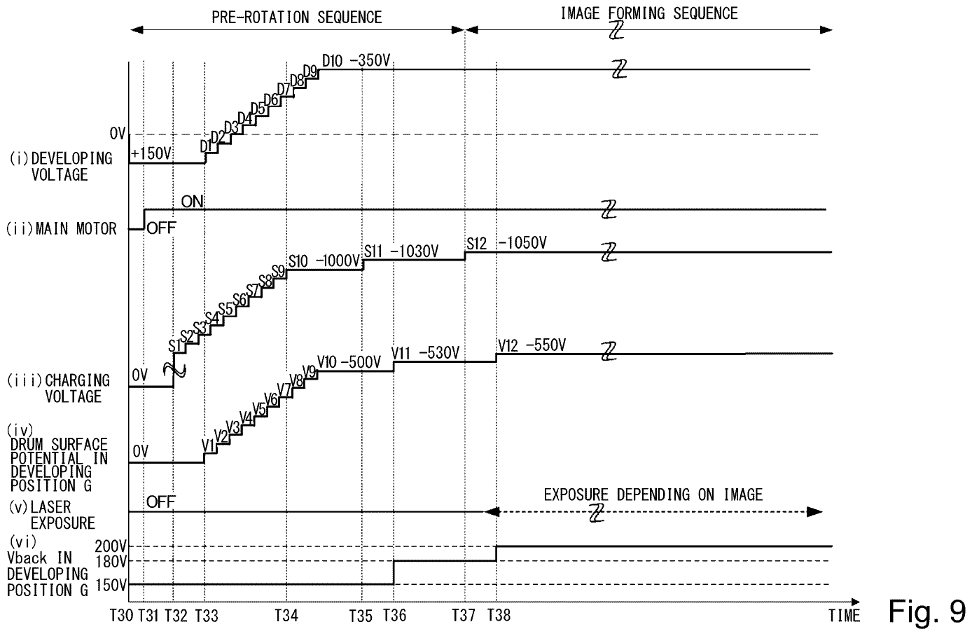

FIG. 9 is a timing chart of a print sequence in the embodiment 3. In the embodiment 3, the dark potential Vd is −550 V, and the light potential Vl is −230 V. In a graph of FIG. 9, (i) to (vi) are similar to (i) to (vi) of the graph of FIG. 5, respectively. Further, in FIG. 9, T30 to T37 show associated timings.

### Pre-Rotation Sequence

First, the pre-rotation sequence will be described. Control until a final stage (T34) of the stepwise rising control of the charging voltage is similar to that in the embodiment 1, and a tenth charging voltage S10 is set to −1000 V. Further, after the charging voltage is raised to the tenth charging voltage S10, the charging voltage is changed to an eleventh charging voltage S11 (−1030 V) in a predetermined timing (T35). Further, the eleventh charging voltage S11 is maintained to before (T37) a start of the image forming sequence. In a retention period of the eleventh charging voltage S11 from T35 to T37, a circumferential direction length of a region of the surface of the photosensitive drum 1 to which the eleventh charging voltage S11 is applied may desirably be longer than a length corresponding to one-full circumference of the transfer roller 5. In the embodiment 3, the circumferential direction length is a length corresponding to two-full circumferences of the transfer roller 5.

The surface potential of the photosensitive drum 1 is set to −50 V as a first surface potential V1 correspondingly to the first charging voltage S1 at the timing of the start of the stepwise rising control of the charging voltage, and is set to −500 V as a tenth surface potential V10 correspondingly to the tenth charging voltage S10. Further, the surface potential of the photosensitive drum 1 becomes an eleventh surface potential V11 (−530 V) corresponding to the eleventh charging voltage S11. As a result, the Vback is changed to 180 V as the second back contrast, and then is maintained.

The developing voltage is controlled so that the Vback as the third back contrast is first maintained at 150 V in the developing position G of the developing nip where the photosensitive drum 1 and the developing roller 42 contact each other. In the embodiment 3, at a timing T33 when rising control of the developing voltage is started, the developing voltage is a first developing voltage D1 (+100 V). The developing voltage becomes a tenth developing voltage D10 (−350 V) at the time of an end of the rising control, and the tenth developing voltage D10 is maintained also during the image forming sequence. For example, when the developing voltage became the tenth developing voltage D10, Vback=|−500 V−(−350 V)|=|−150 V| holds. That is, in the first half (to T35) of the pre-rotation sequence, Vback=150 V is maintained. Further, in a timing T36, Vback=|−530 V−(−350 V)|=|−180 V| holds. That is, in the second half (from T35) of the pre-rotation sequence, the charging voltage is controlled so that Vback=180 V is maintained.

A switching timing between the pre-rotation sequence and the image forming sequence will be described. This switching timing is T37, and is a timing when the region of the photosensitive drum 1 positioned in the transfer position N when the position of 2 mm from the leading end of the recording material S on which the toner image is printed in the transfer position N after the pre-rotation sequence reaches the transfer position N is positioned in the charging position C by being timewisely traced back to the charging position C. That is, a timing when the portion of the photosensitive drum 1 contacting the position of 2 mm from the recording material S in the transfer position N during the recording material S is positioned in a direction opposite to the rotational direction R1 in FIG. 1 is the timing T37.

### Image Forming Sequence

Next, the image forming sequence will be described. In the embodiment 3, as described above, during the image forming sequence, the surface potential of the photosensitive drum 1 is set to −550 V which is an optimum dark potential Vd for the image formation. For that reason, the charging voltage applied to the charging roller 2 by the charging power source 11 is changed from an eleventh charging voltage S11 (−1030 V) to a twelfth charging voltage S12 (−1050 V) at the timing T37. On the other hand, as described above, the developing voltage is maintained at the tenth developing voltage D10 also during the image forming sequence. As a result, in the embodiment 3, during the image forming sequence, the Vback is set to 200 V (=|−550 V−(−350 V)|) as the first back contrast.

An effect in the embodiment 3 is similar to the effect in the embodiment 1 in principle, and therefore, will be omitted here. However, in the embodiment 3, the present disclosure is applied by switching only the charging voltage to a higher value, so that control becomes simple and an advantage such that charging uniformity can be enhanced by making the charging voltage high.

As described above, the engine controller 205 as the controller controls the charging power source so that an absolute value of the charging voltage becomes a value higher than that before switching the charging voltage, when a boundary between the surface of the photosensitive drum providing the third potential difference and the surface of the photosensitive drum providing the second potential difference passes through the charging position. And, the engine controller 205 controls the charging power source so that the absolute value of the charging voltage becomes a value higher than that before switching the charging voltage, when a boundary between the surface of the photosensitive drum providing the second potential difference and the surface of the photosensitive drum providing the first potential difference passes through the charging position.

Further, the engine controller 205 as the controller controls the developing power source so that the developing voltage maintains a predetermined value when a boundary between the surface of the photosensitive drum providing the third potential difference and the surface of the photosensitive drum providing the second potential difference passes through the developing position. And, the engine controller 205 controls the developing power source so that the developing voltage maintains a predetermined value when a boundary between the surface of the photosensitive drum providing the second potential difference and the surface of the photosensitive drum providing the first potential difference passes through the developing position.

As described above, the charging voltage is switched in a higher direction from the first half to the second half of the pre-rotation sequence and then to the image forming sequence. By this, for the Vback, the magnitude relationship of (third back contrast)<(second back contrast)<(first back contrast) is satisfied. For this reason, the memory trace of the portion where the transfer roller 5 and the photosensitive drum 1 contacted each other can be suppressed.

As described above, according to the embodiment 3, it is possible to suppress the image defect occurring in the leading end of the recording material.

### Other Embodiments

The present disclosure can be realized by processing in which a program for realizing one or more functions of the above-described embodiments is supplied to a system or an apparatus through a network or a storage medium and in which one or more processors in a computer of the system or the apparatus reads and executes the program. Further, the present disclosure can also be realized by a circuit (for example, application specific integral circuit (ASIC)) for realizing one or more functions.

According to the present disclosure, the image defect occurring in the leading end of the recording material can be suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-037379 filed on Mar. 10, 2025, which is hereby incorporated by reference herein in its entirety.

What is claimed is:

1. An image forming apparatus configured to execute an image forming operation for forming an image on a recording material, the image forming apparatus comprising:
a photosensitive drum;
a charging roller configured to electrically charge a surface of the photosensitive drum in a charging position where the charging roller contacts the surface of the photosensitive drum;
a charging voltage applying portion configured to apply a charging voltage to the charging roller;
a developing roller configured to supply toner to the surface of the photosensitive drum in a developing position where the developing roller contacts the surface of the photosensitive drum;
a developing voltage applying portion configured to apply a developing voltage to the developing roller;
a transfer roller configured to transfer the toner on the photosensitive drum onto the recording material in a transfer position where the surface of the photosensitive drum contacts the transfer roller;
a transfer voltage applying portion configured to apply a transfer voltage to the transfer roller; and
a controller configured to control the charging voltage applying portion, the developing voltage applying portion, and the transfer voltage applying portion,
wherein a potential of a region of the surface of the photosensitive drum charged by the charging roller is defined as a non-image portion potential,
a potential difference between the non-image portion potential and the developing voltage when the surface of the photosensitive drum is positioned in the developing position before being positioned in the transfer position when the recording material is nipped between the transfer roller and the photosensitive drum is defined as a first potential difference,
the potential difference when the surface of the photosensitive drum is positioned in the developing position immediately before a leading end of the recording material reaches the transfer position and before the surface of the photosensitive drum providing the first potential difference passes through the transfer position is defined as a second potential difference, and
the potential difference when the surface of the photosensitive drum is positioned in the developing position before the surface of the photosensitive drum providing the second potential difference passes through the transfer position and before the surface of the photosensitive drum is positioned in the transfer position when the recording material is not nipped between the transfer roller and the photosensitive drum is defined as a third potential difference, and
wherein in a state in which the transfer voltage is applied in a case where an operation of the image forming apparatus is shifted from a non-image forming operation to the image forming operation, the controller controls the charging voltage and the developing voltage so as to satisfy the following relationship:
(first potential difference)>(second potential difference)>(third potential difference).

2. The image forming apparatus according to claim 1, wherein a length of the surface of the photosensitive drum providing the second potential difference with respect to a rotational direction is longer than a peripheral length of the transfer roller.

3. The image forming apparatus according to claim 1, wherein the controller controls the charging voltage applying portion so that the charging voltage maintains a predetermined value when a boundary between the surface of the photosensitive drum providing the third potential difference and the surface of the photosensitive drum providing the second potential difference passes through the charging position and when a boundary between the surface of the photosensitive drum providing the second potential difference and the surface of the photosensitive drum providing the first potential difference passes through the charging position, and
wherein the controller controls the developing voltage applying portion so that an absolute value of the developing voltage becomes a value lower than that before switching of the developing voltage when the boundary between the surface of the photosensitive drum providing the third potential difference and the surface of the photosensitive drum providing the second potential difference passes through the developing position and when the boundary between the surface of the photosensitive drum providing the second potential difference and the surface of the photosensitive drum providing the first potential difference passes through the developing position.

4. The image forming apparatus according to claim 1, wherein the controller controls the charging voltage applying portion so that an absolute value of the charging voltage becomes a value higher than that before switching of the charging voltage when a boundary between the surface of the photosensitive drum providing the third potential difference and the surface of the photosensitive drum providing the second potential difference passes through the charging position and when a boundary between the surface of the photosensitive drum providing the second potential difference and the surface of the photosensitive drum providing the first potential difference passes through the charging position, and
wherein the controller controls the developing voltage applying portion so that the developing voltage maintains a predetermined value when the boundary between the surface of the photosensitive drum providing the third potential difference and the surface of the photosensitive drum providing the second potential difference passes through the developing position and when the boundary between the surface of the photosensitive drum providing the second potential difference and the surface of the photosensitive drum providing the first potential difference passes through the developing position.

5. The image forming apparatus according to claim 1, wherein a deposition amount per unit area of the toner deposited in a region providing the non-image portion potential by the first potential difference is defined as a first deposition amount, and a deposition amount per unit area of the toner deposited in a region providing the non-image portion potential by a fourth potential difference larger than the first potential difference is defined as a second deposition amount, and
wherein the second deposition amount is larger than the first deposition amount.

6. The image forming apparatus according to claim 5, wherein a deposition amount per unit area of the toner deposited in a region providing the non-image portion potential by a fifth potential difference smaller than the first potential difference is defined as a third deposition amount, and
wherein the third deposition amount is smaller than the first deposition amount.

7. The image forming apparatus according to claim 6, wherein a surface of the recording material on which the image is formed is defined as a front surface, and a surface opposite from the front surface is defined as a back surface,
a deposition amount per unit area of the toner deposited on the back surface by the first potential difference is defined as a fourth deposition amount,
a deposition amount per unit area of the toner deposited on the back surface by the fourth potential difference is defined as a fifth deposition amount, and
wherein the fourth deposition amount is larger than the fifth deposition amount.

8. The image forming apparatus according to claim 7, wherein a deposition amount per unit area of the toner deposited on the back surface by the fifth potential difference is defined as a sixth deposition amount, and
wherein the sixth deposition amount is larger than the fourth deposition amount.

9. The image forming apparatus according to claim 1, wherein the developing roller contacts the surface of the photosensitive drum in the developing position from a start to an end of the image forming operation.
